(19) United States
(12) Patent Application Publication
(10) Pub. No.: US 2025/0184957 A1
(43) Pub. Date: Jun. 5, 2025

(54) SYSTEMS AND METHODS FOR UL-OFDMA WI-FI SENSING USING RANGING

(71) Applicant: COGNITIVE SYSTEMS CORP., Waterloo (CA)

(72) Inventors: Chris BEG, Waterloo, Ontario (CA); Mohammad OMER, Waterloo, Ontario (CA)

(21) Appl. No.: 18/844,309

(22) PCT Filed: Apr. 3, 2023
(86) PCT No.: PCT/IB2023/053363

§ 371 Date: Sep. 5, 2024

Related U.S. Application Data
(60) Provisional application No. 63/336,478, filed on Apr. 29, 2022.
(60) Provisional application No. 63/327,010, filed on Apr. 4, 2022.

(51) Int. Cl. H04W 64/00; H04W 28/20; H04W 72/0453

(52) U.S. Cl. CPC H04W 64/006; H04W 28/20; H04W 72/0453

(57) ABSTRACT

A method is described for Wi-Fi sensing. The method is carried out by a networking device configured to operate as a sensing initiator and includes at least one processor configured to execute instructions. Initially, a multiway sensing trigger message is transmitted via a transmitting antenna of the networking device. A plurality of sensing transmissions from a plurality of sensing responders responsive to the multiway sensing trigger message is simultaneously received by the networking device via a receiving antenna. A sensing measurement is performed on at least one of the plurality of sensing transmissions.

### TECHNICAL FIELD

The present disclosure generally relates to systems and methods for Wi-Fi sensing. In particular, the present disclosure relates to systems and methods for uplink orthogonal frequency division multiple access (UL-OFDMA) Wi-Fi sensing using ranging.

### BACKGROUND OF THE DISCLOSURE

A Wi-Fi sensing system may be configured to detect features of interest in a sensing space. The Wi-Fi sensing system may be a network of Wi-Fi-enabled devices which are part of an IEEE 802.11 network (sometimes referred to as a basic service set (BSS) or extended service set (ESS)). The features of interest may include motion of objects and motion tracking, presence detection, intrusion detection, gesture recognition, fall detection, breathing rate detection, and other applications. The sensing space may refer to any physical space in which a Wi-Fi sensing system may operate and may include a place of abode, a place of work, a shopping mall, a sports hall or sports stadium, a garden, or any other physical space.

### BRIEF SUMMARY OF THE DISCLOSURE

The present disclosure generally relates to systems and methods for Wi-Fi sensing. In particular, the present disclosure relates to systems and methods for uplink orthogonal frequency division multiple access (UL-OFDMA) Wi-Fi sensing using ranging.

Systems and methods are provided for Wi-Fi sensing. In an example embodiment, a method for Wi-Fi sensing is described. The method is carried out by a networking device configured to operate as a sensing initiator. The networking device operating as a sensing initiator includes at least one processor configured to execute instructions. The method includes transmitting, via a transmitting antenna of the networking device, a multiway sensing trigger message, and receiving simultaneously, via a receiving antenna of the networking device, a plurality of sensing transmissions from a plurality of sensing responders responsive to the multiway sensing trigger message. In some embodiments, the method includes performing, by the at least one processor, a sensing measurement on at least one of the plurality of sensing transmissions.

In some embodiments, the multiway sensing trigger message includes an indication of bandwidth allocation for use by the respective plurality of sensing responders.

In some embodiments, a first bandwidth allocation of a first sensing responder from the plurality of sensing responders is greater than a second bandwidth allocation of a second sensing responder from the plurality of sensing responders.

In some embodiments, the first bandwidth allocation is allotted for detection mode sensing transmissions and the second bandwidth allocation is allotted for scanning mode sensing transmissions.

In some embodiments, respective bandwidth allocations for use by the respective plurality of sensing responders are determined according to sensing modes of respective ones of the plurality of sensing responders.

In some embodiments, the respective bandwidth allocations include at least two bandwidth allocations of different sizes.

In some embodiments, the multiway sensing trigger message includes requested sensing configuration parameters.

In some embodiments, the sensing configuration parameters include a plurality of specific sensing configuration parameter sets, each associated with a respective one of the plurality of sensing responders.

In some embodiments, at least one of the plurality of sensing transmissions includes delivered sensing configuration parameters different than the requested sensing configuration parameters.

In some embodiments, the multiway sensing trigger message includes a request for a sensing transmission and an indication that no further action is required subsequent to the sensing transmission.

In some embodiments, the multiway sensing trigger message is a sensing polling trigger frame.

In some embodiments, the multiway sensing trigger message is configured to request a sensing transmission response from a sensing responder of the plurality of sensing responders and to request a non-sensing transmission response from an additional networking device.

In some embodiments, receiving simultaneously the plurality of sensing transmissions includes receiving the plurality of sensing transmissions during a same transmission opportunity period.

In some embodiments, receiving simultaneously the plurality of sensing transmissions includes receiving the plurality of sensing transmissions within a time interval of defined length.

In some embodiments, receiving simultaneously the plurality of sensing transmissions includes identifying each of the plurality of sensing transmissions in a different bandwidth allocation.

In some embodiments, the networking device is an access point and the respective plurality of sensing responders are stations associated with the access point.

Other aspects and advantages of the disclosure will become apparent from the following detailed description, taken in conjunction with the accompanying drawings, which illustrate by way of example, the principles of the disclosure.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1 is a diagram showing an example wireless communication system;

FIG. 2A and FIG. 2B are diagrams showing example wireless signals communicated between wireless communication devices;

FIG. 3A and FIG. 3B are plots showing examples of channel responses computed from the wireless signals communicated between wireless communication devices in FIG. 2A and FIG. 2B;

FIG. 4A and FIG. 4B are diagrams showing example channel responses associated with motion of an object in distinct regions of a space;

FIG. 4C and FIG. 4D are plots showing the example channel responses of FIG. 4A and FIG. 4B overlaid on an example channel response associated with no motion occurring in the space;

FIG. 5 depicts some of an architecture of an implementation of a system for Wi-Fi sensing, according to some embodiments;

FIG. 6 depicts a process for making a sensing measurement, according to some embodiments;

FIG. 7 depicts an example of an uplink orthogonal frequency division multiple access (UL-OFDMA) transmission procedure, according to some embodiments;

FIG. 8 depicts a process illustrating an example of trigger-based (TB) fine timing measurement (FTM) procedure for ranging, according to some embodiments;

FIG. 9 depicts a format of high efficiency trigger-based physical-layer protocol data unit (HE TB PPDU), according to some embodiments;

FIG. 10 depicts a format of a trigger frame, according to some embodiments;

FIG. 11 depicts a format of a common info field of the trigger frame, according to some embodiments;

FIG. 12 depicts a format of a trigger dependent common info subfield of the common info field in the trigger frame, according to some embodiments;

FIG. 13 depicts a process illustrating a sensing polling trigger frame and a modified poll response, according to some embodiments;

FIG. 14 depicts a format of user info field for a sensing polling trigger frame, according to some embodiments;

FIG. 15 depicts a format of user info field format for an enhanced ranging trigger frame, according to some embodiments;

FIG. 16 depicts a format of a clear to send (CTS) frame, according to some embodiments;

FIG. 17 depicts a format of a CTS frame modified for sensing based on ranging, according to some embodiments;

FIG. 18 illustrates a format of a user info field of a ranging trigger frame (poll), according to some embodiments;

FIG. 19 depicts resource unit (RU) user info field format for poll and report ranging trigger, according to some embodiments; and

FIG. 20 depicts a flowchart for performing a sensing measurement on at least one of a plurality of sensing transmissions, according to some embodiments.

### DETAILED DESCRIPTION

In some aspects of what is described herein, a wireless sensing system may be used for a variety of wireless sensing applications by processing wireless signals (e.g., radio frequency (RF) signals) transmitted through a space between wireless communication devices. Example wireless sensing applications include motion detection, which can include the following: detecting motion of objects in the space, motion tracking, breathing detection, breathing monitoring, presence detection, gesture detection, gesture recognition, human detection (moving and stationary human detection), human tracking, fall detection, speed estimation, intrusion detection, walking detection, step counting, respiration rate detection, apnea estimation, posture change detection, activity recognition, gait rate classification, gesture decoding, sign language recognition, hand tracking, heart rate estimation, breathing rate estimation, room occupancy detection, human dynamics monitoring, and other types of motion detection applications. Other examples of wireless sensing applications include object recognition, speaking recognition, keystroke detection and recognition, tamper detection, touch detection, attack detection, user authentication, driver fatigue detection, traffic monitoring, smoking detection, school violence detection, human counting, human recognition, bike localization, human queue estimation, Wi-Fi imaging, and other types of wireless sensing applications. For instance, the wireless sensing system may operate as a motion detection system to detect the existence and location of motion based on Wi-Fi signals or other types of wireless signals. As described in more detail below, a wireless sensing system may be configured to control measurement rates, wireless connections, and device participation, for example, to improve system operation or to achieve other technical advantages. The system improvements and technical advantages achieved when the wireless sensing system is used for motion detection are also achieved in examples where the wireless sensing system is used for another type of wireless sensing application.

In some example wireless sensing systems, a wireless signal includes a component (e.g., a synchronization preamble in a Wi-Fi PHY frame, or another type of component) that wireless devices can use to estimate a channel response or other channel information, and the wireless sensing system can detect motion (or another characteristic depending on the wireless sensing application) by analyzing changes in the channel information collected over time. In some examples, a wireless sensing system can operate similar to a bistatic radar system, where a Wi-Fi access point (AP) assumes the receiver role, and each Wi-Fi device (station (STA), node, or peer) connected to the AP assumes the transmitter role. The wireless sensing system may trigger a connected device to generate a transmission and produce a channel response measurement at a receiver device. This triggering process can be repeated periodically to obtain a sequence of time variant measurements. A wireless sensing algorithm may then receive the generated time-series of channel response measurements (e.g., computed by Wi-Fi receivers) as input, and through a correlation or filtering process, may then make a determination (e.g., determine if there is motion or no motion within the environment represented by the channel response, for example, based on changes or patterns in the channel estimations). In examples where the wireless sensing system detects motion, it may also be possible to identify a location of the motion within the environment based on motion detection results among a number of wireless devices.

Accordingly, wireless signals received at each of the wireless communication devices in a wireless communication network may be analyzed to determine channel information for the various communication links (between respective pairs of wireless communication devices) in the network. The channel information may be representative of a physical medium that applies a transfer function to wireless signals that traverse a space. In some instances, the channel information includes a channel response. Channel responses can characterize a physical communication path, representing the combined effect of, for example, scattering, fading, and power decay within the space between the transmitter and receiver. In some instances, the channel information includes beamforming state information (e.g., a feedback matrix, a steering matrix, channel state information, etc.) provided by a beamforming system. Beamforming is a signal processing technique often used in multi-antenna (multiple-input/multiple-output (MIMO)) radio systems for directional signal transmission or reception. Beamforming can be achieved by operating elements in an antenna array in such a way that signals at some angles experience constructive interference while others experience destructive interference.

The channel information for each of the communication links may be analyzed (e.g., by a hub device or other device in a wireless communication network, or a sensing transmitter, sensing receiver, or sensing initiator communicably coupled to the network) to, for example, detect whether motion has occurred in the space, to determine a relative location of the detected motion, or both. In some aspects, the channel information for each of the communication links may be analyzed to detect whether an object is present or absent, e.g., when no motion is detected in the space.

In some cases, a wireless sensing system can control a node measurement rate. For instance, a Wi-Fi motion system may configure variable measurement rates (e.g., channel estimation/environment measurement/sampling rates) based on criteria given by a current wireless sensing application (e.g., motion detection). In some implementations, when no motion is present or detected for a period of time, for example, the wireless sensing system can reduce the rate that the environment is measured, such that the connected device will be triggered or caused to make sensing transmissions or sensing measurements less frequently. In some implementations, when motion is present, for example, the wireless sensing system can increase the triggering rate or sensing transmission rate or sensing measurement rate to produce a time-series of measurements with finer time resolution. Controlling the variable sensing measurement rate can allow energy conservation (through the device triggering), reduce processing (less data to correlate or filter), and improve resolution during specified times.

In some cases, a wireless sensing system can perform band steering or client steering of nodes throughout a wireless network, for example, in a Wi-Fi multi-AP or extended service set (ESS) topology, multiple coordinating wireless APs each provide a basic service set (BSS) which may occupy different frequency bands and allow devices to transparently move between from one participating AP to another (e.g., mesh). For instance, within a home mesh network, Wi-Fi devices can connect to any of the APs, but typically select one with good signal strength. The coverage footprint of the mesh APs typically overlap, often putting each device within communication range or more than one AP. If the AP supports multi-bands (e.g., 2.4 GHz and 5 GHZ), the wireless sensing system may keep a device connected to the same physical AP but instruct it to use a different frequency band to obtain more diverse information to help improve the accuracy or results of the wireless sensing algorithm (e.g., motion detection algorithm). In some implementations, the wireless sensing system can change a device from being connected to one mesh AP to being connected to another mesh AP. Such device steering can be performed, for example, during wireless sensing (e.g., motion detection), based on criteria detected in a specific area to improve detection coverage, or to better localize motion within an area.

In some cases, beamforming may be performed between wireless communication devices based on some knowledge of the communication channel (e.g., through feedback properties generated by a receiver), which can be used to generate one or more steering properties (e.g., a steering matrix) that are applied by a transmitter device to shape the transmitted beam/signal in a particular direction or directions. Thus, changes to the steering or feedback properties used in the beamforming process indicate changes, which may be caused by moving objects, in the space accessed by the wireless communication system. For example, a motion may be detected by substantial changes in the communication channel, e.g., as indicated by a channel response, or steering or feedback properties, or any combination thereof, over a period of time.

In some implementations, for example, a steering matrix may be generated at a transmitter device (beamformer) based on a feedback matrix provided by a receiver device (beamformee) based on channel sounding. Because the steering and feedback matrices are related to propagation characteristics of the channel, these matrices change as objects move within the channel. Changes in the channel characteristics are accordingly reflected in these matrices, and by analyzing the matrices, motion can be detected, and different characteristics of the detected motion can be determined. In some implementations, a spatial map may be generated based on one or more beamforming matrices. The spatial map may indicate a general direction of an object in a space relative to a wireless communication device. In some cases, many beamforming matrices (e.g., feedback matrices or steering matrices) may be generated to represent a multitude of directions that an object may be located relative to a wireless communication device. These many beamforming matrices may be used to generate the spatial map. The spatial map may be used to detect the presence of motion in the space or to detect a location of the detected motion.

In some instances, a motion detection system can control a variable device measurement rate in a motion detection process. For example, a feedback control system for a multi-node wireless motion detection system may adaptively change the sample rate based on the environmental conditions. In some cases, such controls can improve operation of the motion detection system or provide other technical advantages. For example, the measurement rate may be controlled in a manner that optimizes or otherwise improves air-time usage versus detection ability suitable for a wide range of different environments and different motion detection applications. The measurement rate may be controlled in a manner that reduces redundant measurement data to be processed, thereby reducing processor load/power requirements. In some cases, the measurement rate is controlled in a manner that is adaptive, for instance, an adaptive sample can be controlled individually for each participating device. An adaptive sample rate can be used with a tuning control loop for different use cases, or device characteristics.

In some cases, a wireless sensing system can allow devices to dynamically indicate and communicate their wireless sensing capability or wireless sensing willingness to the wireless sensing system. For example, there may be times when a device does not want to be periodically interrupted or triggered to transmit a wireless signal that would allow the AP to produce a channel measurement. For instance, if a device is sleeping, frequently waking the device up to transmit or receive wireless sensing signals could consume resources (e.g., causing a cell phone battery to discharge faster). These and other events could make a device willing or not willing to participate in wireless sensing system operations. In some cases, a cell phone running on its battery may not want to participate, but when the cell phone is plugged into the charger, it may be willing to participate. Accordingly, if the cell phone is unplugged, it may indicate to the wireless sensing system to exclude the cell phone from participating; whereas if the cell phone is plugged in, it may indicate to the wireless sensing system to include the cell phone in wireless sensing system operations. In some cases, if a device is under load (e.g., a device streaming audio or video) or busy performing a primary function, the device may not want to participate; whereas when the same device's load is reduced and participating will not interfere with a primary function, the device may indicate to the wireless sensing system that it is willing to participate.

Example wireless sensing systems are described below in the context of motion detection (detecting motion of objects in the space, motion tracking, breathing detection, breathing monitoring, presence detection, gesture detection, gesture recognition, human detection (moving and stationary human detection), human tracking, fall detection, speed estimation, intrusion detection, walking detection, step counting, respiration rate detection, apnea estimation, posture change detection, activity recognition, gait rate classification, gesture decoding, sign language recognition, hand tracking, heart rate estimation, breathing rate estimation, room occupancy detection, human dynamics monitoring, and other types of motion detection applications). However, the operation, system improvements, and technical advantages achieved when the wireless sensing system is operating as a motion detection system are also applicable in examples where the wireless sensing system is used for another type of wireless sensing application.

In various embodiments of the disclosure, non-limiting definitions of one or more terms that will be used in the document are provided below.

A term “measurement campaign” may refer to a bi-directional series of one or more sensing transmissions between a sensing receiver and a sensing transmitter that allows a series of one or more sensing measurements to be computed.

A term “transmission opportunity (TXOP)” may refer to a negotiated interval of time during which a particular quality of service (QOS) station (e.g., a sensing initiator or sensing transmitter) may have the right to initiate a frame exchange onto a wireless medium. A QoS access category (AC) of the transmission opportunity may be requested as part of a negotiation.

A term “Quality of Service (QOS) access category (AC)” may refer to an identifier for a frame which classifies a priority of transmission that the frame requires. In an example, four QoS access categories are defined namely AC_VI: Video, AC_VO: Voice, AC_BE: Best-Effort, and AC_BK: Background. Further, each QoS access category may have differing transmission opportunity parameters defined for it.

A term “transmission parameters” may refer to a set of IEEE 802.11 PHY transmitter configuration parameters which are defined as part of transmission vector (TXVECTOR) corresponding to a specific PHY and which are configurable for each PHY-layer Protocol Data Unit (PPDU) transmission.

A term “PHY-layer Protocol Data Unit (PPDU)” may refer to a data unit that includes preamble and data fields. The preamble field may include the transmission vector format information, and the data field may include payload and higher layer headers.

A term “resource unit (RU)” may refer to an allocation of orthogonal frequency division multiplexing (OFDM) channels which may be used to carry a modulated signal. An RU may include a variable number of carriers depending on the mode of the modem.

A term “sensing transmitter” may refer to a device that sends transmissions (for example, NDPs or PPDUs or any other transmissions) used for sensing measurements (for example, channel state information) in a Wi-Fi sensing session. A station (STA) is an example of a sensing transmitter. In some examples, an access point (AP) may also be a sensing transmitter for Wi-Fi sensing purposes in the example where a STA acts as a sensing receiver.

A term “sensing receiver” may refer to a device that receives transmissions (for example, NDPs or PPDUs or any other transmissions which may be opportunistically used for sensing measurements) sent by a sensing transmitter and performs one or more sensing measurements (for example, channel state information) in a Wi-Fi sensing session. An AP is an example of a sensing receiver. In some examples, a STA may also be a sensing receiver, for example, in a mesh network scenario.

A term “sensing initiator” may refer to a device that initiates a Wi-Fi sensing session. The role of sensing initiator may be taken on by the sensing receiver, the sensing transmitter, or a separate device that includes the sensing algorithm.

A term “sensing responder” may refer to a device that participates in a Wi-Fi sensing session initiated by a sensing initiator. In examples, multiple sensing responders may participate in a measurement phase and a reporting phase of the Wi-Fi sensing session.

A term “Null Data PPDU (NDP)” may refer to a PPDU that does not include data fields. In an example, Null Data PPDU may be used for sensing transmissions where in examples it is the Medium Access Control (MAC) header that includes the information required.

A term “sensing transmission” may refer to any transmission made from a sensing transmitter to a sensing receiver that may be used to make a sensing measurement. In an example, sensing transmission may also be referred to as wireless sensing signal or wireless signal.

A term “sensing measurement” may refer to a measurement of a state of a channel i.e., channel state information measurement, between a sensing transmitter and a sensing receiver derived from a transmission, for example, a sensing transmission.

A term “delivered transmission configuration” may refer to transmission parameters applied by the sensing transmitter to a sensing transmission.

A term “requested transmission configuration” may refer to requested transmission parameters of the sensing transmitter to be used when sending a sensing transmission.

A term “scanning mode” may refer to an operational mode having a purpose to identify motion or movement. The resolution in scanning mode is low and may not be sufficient for detecting fine motion. In an example, a Wi-Fi sensing system may operate in a scanning mode.

A term “detection mode” may refer to an operational mode having a purpose to detect motion or movement (for example, of an object that was previously identified) at a high resolution. In an example, a Wi-Fi sensing system may operate in a detection mode.

A term “sensing algorithm” may refer to a computational algorithm that achieves a sensing goal. The sensing algorithm may be executed on any device in a Wi-Fi sensing system.

A “transmission channel” may refer to a tunable channel on which the sensing receiver performs a sensing measurement and/or on which the sensing transmitter performs a sensing transmission.

A term “feature of interest” may refer to an item or state of an item which is positively detected and/or identified by a sensing algorithm.

A term “sensing space” may refer to a physical space in which a Wi-Fi sensing system may operate.

A term “association ID (AID)” may refer to a value that an AP assigns to a STA, for example, when the STA associates with the AP. In an example, the AID may be in a range of 1 to 2007.

A term “ranging session ID (RSID)” may refer to a value assigned to an unassociated STA.

A term “clear to send (CTS)” may refer to a function that may be used to let the AP know that the STA is ready (or is clear without channel conflicts) to send or receive the data.

A term “Wi-Fi sensing session” may refer to a period during which objects in a sensing space may be probed, detected and/or characterized. In an example, during a Wi-Fi sensing session, several devices participate in, and thereby contribute to the generation of sensing measurements. A Wi-Fi sensing session may also be referred to as a WLAN sensing session or simply a sensing session.

An AP may be a device that provides access to distribution system services via a wireless link for one or more STAs. The AP may have a distribution system access function.

For purposes of reading the description of the various embodiments below, the following descriptions of the sections of the specifications and their respective contents may be helpful:

Section A describes a wireless communications system, wireless transmissions and sensing measurements which may be useful for practicing embodiments described herein.

Section B describes systems and methods that are useful for a Wi-Fi sensing system configured to send sensing transmissions and make sensing measurements.

Section C describes embodiments of systems and methods for uplink orthogonal frequency division multiple access (UL-OFDMA) Wi-Fi sensing using ranging.

### A. Wireless Communications System, Wireless Transmissions, and Sensing Measurements

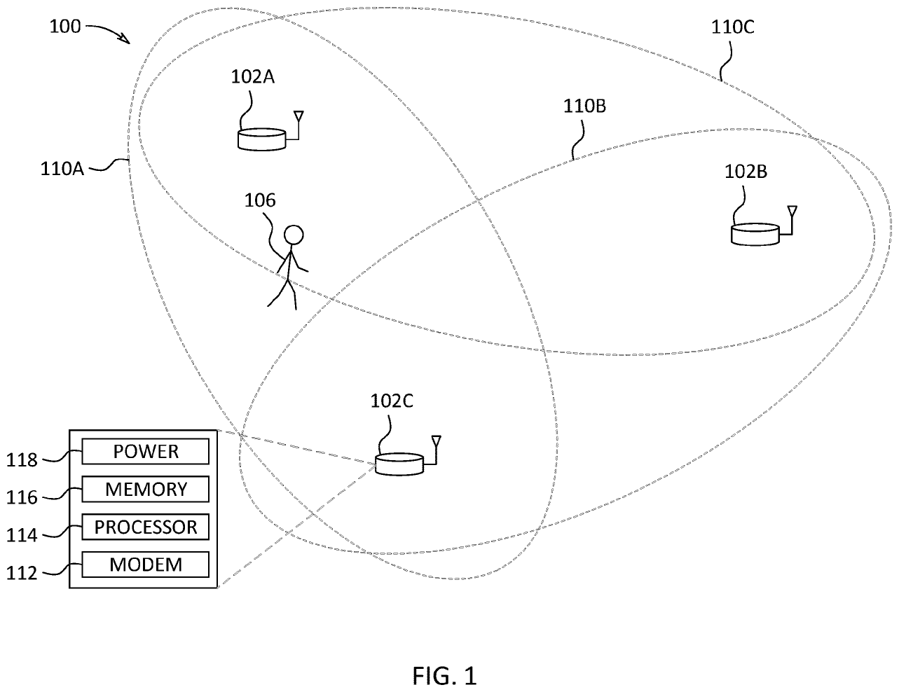

FIG. 1 illustrates wireless communication system 100. Wireless communication system 100 includes three wireless communication devices: first wireless communication device 102A, second wireless communication device 102B, and third wireless communication device 102C. Wireless communication system 100 may include additional wireless communication devices and other components (e.g., additional wireless communication devices, one or more network servers, network routers, network switches, cables, or other communication links, etc.).

Wireless communication devices 102A, 102B, 102C can operate in a wireless network, for example, according to a wireless network standard or another type of wireless communication protocol. For example, the wireless network may be configured to operate as a wireless local area network (WLAN), a personal area network (PAN), a metropolitan area network (MAN), or another type of wireless network. Examples of WLANs include networks configured to operate according to one or more of the 802.11 family of standards developed by IEEE (e.g., Wi-Fi networks), and others. Examples of PANs include networks that operate according to short-range communication standards (e.g., Bluetooth®., Near Field Communication (NFC), ZigBee), millimeter wave communications, and others.

In some implementations, wireless communication devices 102A, 102B, 102C may be configured to communicate in a cellular network, for example, according to a cellular network standard. Examples of cellular networks include networks configured according to 2G standards such as Global System for Mobile (GSM) and Enhanced Data rates for GSM Evolution (EDGE) or EGPRS; 3G standards such as code division multiple access (CDMA), wideband code division multiple access (WCDMA), Universal Mobile Telecommunications System (UMTS), and time division synchronous code division multiple access (TD-SCDMA); 4G standards such as Long-Term Evolution (LTE) and LTE-Advanced (LTE-A); 5G standards, and others.

In the example shown in FIG. 1, wireless communication devices 102A, 102B, 102C can be, or they may include standard wireless network components. For example, wireless communication devices 102A, 102B, 102C may be commercially-available Wi-Fi APs or another type of wireless access point (WAP) performing one or more operations as described herein that are embedded as instructions (e.g., software or firmware) on the modem of the WAP. In some cases, wireless communication devices 102A, 102B, 102C may be nodes of a wireless mesh network, such as, for example, a commercially-available mesh network system (e.g., Plume Wi-Fi, Google Wi-Fi, Qualcomm Wi-Fi SoN, etc.). In some cases, another type of standard or conventional Wi-Fi transmitter device may be used. In some instances, one or more of wireless communication devices 102A, 102B, 102C may be implemented as WAPs in a mesh network, while other wireless communication device(s) 102A, 102B, 102C are implemented as leaf devices (e.g., mobile devices, smart devices, etc.) that access the mesh network through one of the WAPs. In some cases, one or more of wireless communication devices 102A, 102B, 102C is a mobile device (e.g., a smartphone, a smart watch, a tablet, a laptop computer, etc.), a wireless-enabled device (e.g., a smart thermostat, a Wi-Fi enabled camera, a smart TV), or another type of device that communicates in a wireless network.

Wireless communication devices 102A, 102B, 102C may be implemented without Wi-Fi components; for example, other types of standard or non-standard wireless communication may be used for motion detection. In some cases, wireless communication devices 102A, 102B, 102C can be, or they may be part of, a dedicated motion detection system. For example, the dedicated motion detection system can include a hub device and one or more beacon devices (as remote sensor devices), and wireless communication devices 102A, 102B, 102C can be either a hub device or a beacon device in the motion detection system.

As shown in FIG. 1, wireless communication device 102C includes modem 112, processor 114, memory 116, and power unit 118; any of wireless communication devices 102A, 102B, 102C in wireless communication system 100 may include the same, additional, or different components, and the components may be configured to operate as shown in FIG. 1 or in another manner. In some implementations, modem 112, processor 114, memory 116, and power unit 118 of a wireless communication device are housed together in a common housing or other assembly. In some implementations, one or more of the components of a wireless communication device can be housed separately, for example, in a separate housing or other assembly.

Modem 112 can communicate (receive, transmit, or both) wireless signals. For example, modem 112 may be configured to communicate RF signals formatted according to a wireless communication standard (e.g., Wi-Fi or Bluetooth). Modem 112 may be implemented as the example wireless network modem 112 shown in FIG. 1, or may be implemented in another manner, for example, with other types of components or subsystems. In some implementations, modem 112 includes a radio subsystem and a baseband subsystem. In some cases, the baseband subsystem and radio subsystem can be implemented on a common chip or chipset, or they may be implemented in a card or another type of assembled device. The baseband subsystem can be coupled to the radio subsystem, for example, by leads, pins, wires, or other types of connections.

In some cases, a radio subsystem in modem 112 can include one or more antennas and RF circuitry. The RF circuitry can include, for example, circuitry that filters, amplifies, or otherwise conditions analog signals, circuitry that up-converts baseband signals to RF signals, circuitry that down-converts RF signals to baseband signals, etc. Such circuitry may include, for example, filters, amplifiers, mixers, a local oscillator, etc. The radio subsystem can be configured to communicate radio frequency wireless signals on the wireless communication channels. As an example, the radio subsystem may include a radio chip, an RF front end, and one or more antennas. A radio subsystem may include additional or different components. In some implementations, the radio subsystem can be or may include the radio electronics (e.g., RF front end, radio chip, or analogous components) from a conventional modem, for example, from a Wi-Fi modem, pico base station modem, etc. In some implementations, the antenna includes multiple antennas.

In some cases, a baseband subsystem in modem 112 can include, for example, digital electronics configured to process digital baseband data. As an example, the baseband subsystem may include a baseband chip. A baseband subsystem may include additional or different components. In some cases, the baseband subsystem may include a digital signal processor (DSP) device or another type of processor device. In some cases, the baseband system includes digital processing logic to operate the radio subsystem, to communicate wireless network traffic through the radio subsystem, to detect motion based on motion detection signals received through the radio subsystem or to perform other types of processes. For instance, the baseband subsystem may include one or more chips, chipsets, or other types of devices that are configured to encode signals and deliver the encoded signals to the radio subsystem for transmission, or to identify and analyze data encoded in signals from the radio subsystem (e.g., by decoding the signals according to a wireless communication standard, by processing the signals according to a motion detection process, or otherwise).

In some instances, the radio subsystem in modem 112 receives baseband signals from the baseband subsystem, up-converts the baseband signals to RF signals, and wirelessly transmits the RF signals (e.g., through an antenna). In some instances, the radio subsystem in modem 112 wirelessly receives RF signals (e.g., through an antenna), down-converts the RF to baseband signals, and sends the baseband signals to the baseband subsystem. The signals exchanged between the radio subsystem and the baseband subsystem may be digital or analog signals. In some examples, the baseband subsystem includes conversion circuitry (e.g., a digital-to-analog converter, an analog-to-digital converter) and exchanges analog signals with the radio subsystem. In some examples, the radio subsystem includes conversion circuitry (e.g., a digital-to-analog converter, an analog-to-digital converter) and exchanges digital signals with the baseband subsystem.

In some cases, the baseband subsystem of modem 112 can communicate wireless network traffic (e.g., data packets) in the wireless communication network through the radio subsystem on one or more network traffic channels. The baseband subsystem of modem 112 may also transmit or receive (or both) signals (e.g., motion probe signals or motion detection signals) through the radio subsystem on a dedicated wireless communication channel. In some instances, the baseband subsystem generates motion probe signals for transmission, for example, to probe a space for motion. In some instances, the baseband subsystem processes received motion detection signals (signals based on motion probe signals transmitted through the space), for example, to detect motion of an object in a space.

Processor 114 can execute instructions, for example, to generate output data based on data inputs. The instructions can include programs, codes, scripts, or other types of data stored in memory. Additionally, or alternatively, the instructions can be encoded as pre-programmed or re-programmable logic circuits, logic gates, or other types of hardware or firmware components. Processor 114 may be or include a general-purpose microprocessor, as a specialized co-processor or another type of data processing apparatus. In some cases, processor 114 performs high level operation of the wireless communication device 102C. For example, processor 114 may be configured to execute or interpret software, scripts, programs, functions, executables, or other instructions stored in memory 116. In some implementations, processor 114 may be included in modem 112.

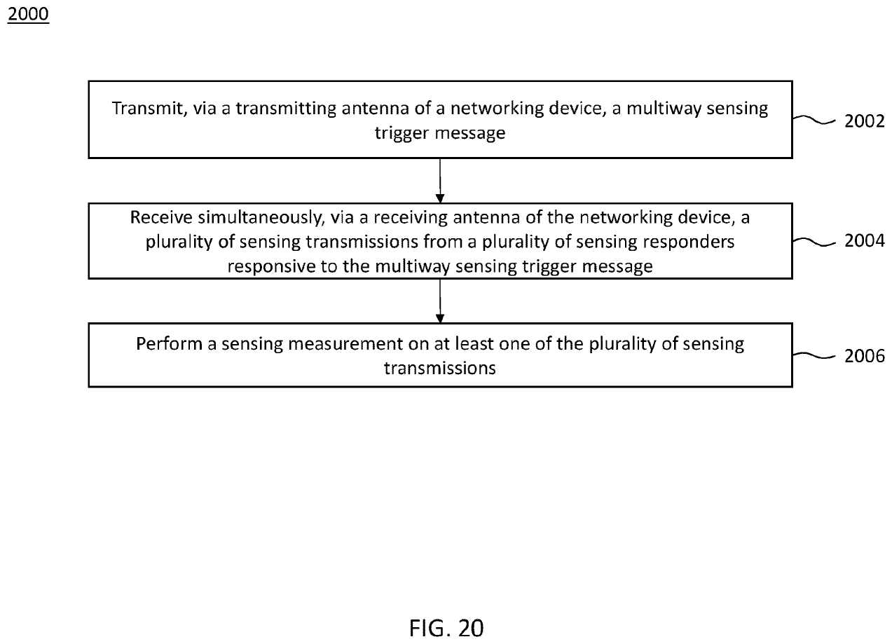

Memory 116 can include computer-readable storage media, for example, a volatile memory device, a non-volatile memory device, or both. Memory 116 can include one or more read-only memory devices, random-access memory devices, buffer memory devices, or a combination of these and other types of memory devices. In some instances, one or more components of the memory can be integrated or otherwise associated with another component of wireless communication device 102C. Memory 116 may store instructions that are executable by processor 114. For example, the instructions may include instructions for time-aligning signals using an interference buffer and a motion detection buffer, such as through one or more of the operations of the example process of FIG. 20. Power unit 118 provides power to the other components of wireless communication device 102C. For example, the other components may operate based on electrical power provided by power unit 118 through a voltage bus or other connection. In some implementations, power unit 118 includes a battery or a battery system, for example, a rechargeable battery. In some implementations, power unit 118 includes an adapter (e.g., an alternating current (AC) adapter) that receives an external power signal (from an external source) and coverts the external power signal to an internal power signal conditioned for a component of wireless communication device 102C. Power unit 118 may include other components or operate in another manner.

In the example shown in FIG. 1, wireless communication devices 102A, 102B transmit wireless signals (e.g., according to a wireless network standard, a motion detection protocol, or otherwise). For instance, wireless communication devices 102A, 102B may broadcast wireless motion probe signals (e.g., reference signals, beacon signals, status signals, etc.), or they may send wireless signals addressed to other devices (e.g., a user equipment, a client device, a server, etc.), and the other devices (not shown) as well as wireless communication device 102C may receive the wireless signals transmitted by wireless communication devices 102A, 102B. In some cases, the wireless signals transmitted by wireless communication devices 102A, 102B are repeated periodically, for example, according to a wireless communication standard or otherwise.

In the example shown, wireless communication device 102C processes the wireless signals from wireless communication devices 102A, 102B to detect motion of an object in a space accessed by the wireless signals, to determine a location of the detected motion, or both. For example, wireless communication device 102C may perform one or more operations of the example process described below with respect to FIG. 20, or another type of process for detecting motion or determining a location of detected motion. The space accessed by the wireless signals can be an indoor or outdoor space, which may include, for example, one or more fully or partially enclosed areas, an open area without enclosure, etc. The space can be or can include an interior of a room, multiple rooms, a building, or the like. In some cases, the wireless communication system 100 can be modified, for instance, such that wireless communication device 102C can transmit wireless signals and wireless communication devices 102A, 102B can processes the wireless signals from wireless communication device 102C to detect motion or determine a location of detected motion.

The wireless signals used for motion detection can include, for example, a beacon signal (e.g., Bluetooth Beacons, Wi-Fi Beacons, other wireless beacon signals), another standard signal generated for other purposes according to a wireless network standard, or non-standard signals (e.g., random signals, reference signals, etc.) generated for motion detection or other purposes. In examples, motion detection may be carried out by analyzing one or more training fields carried by the wireless signals or by analyzing other data carried by the signal. In some examples data will be added for the express purpose of motion detection or the data used will nominally be for another purpose and reused or repurposed for motion detection. In some examples, the wireless signals propagate through an object (e.g., a wall) before or after interacting with a moving object, which may allow the moving object's movement to be detected without an optical line-of-sight between the moving object and the transmission or receiving hardware. Based on the received signals, wireless communication device 102C may generate motion detection data. In some instances, wireless communication device 102C may communicate the motion detection data to another device or system, such as a security system, which may include a control center for monitoring movement within a space, such as a room, building, outdoor area, etc.

In some implementations, wireless communication devices 102A, 102B can be modified to transmit motion probe signals (which may include, e.g., a reference signal, beacon signal, or another signal used to probe a space for motion) on a separate wireless communication channel (e.g., a frequency channel or coded channel) from wireless network traffic signals. For example, the modulation applied to the payload of a motion probe signal and the type of data or data structure in the payload may be known by wireless communication device 102C, which may reduce the amount of processing that wireless communication device 102C performs for motion sensing. The header may include additional information such as, for example, an indication of whether motion was detected by another device in communication system 100, an indication of the modulation type, an identification of the device transmitting the signal, etc.

In the example shown in FIG. 1, wireless communication system 100 is a wireless mesh network, with wireless communication links between each of wireless communication devices 102. In the example shown, the wireless communication link between wireless communication device 102C and wireless communication device 102A can be used to probe motion detection field 110A, the wireless communication link between wireless communication device 102C and wireless communication device 102B can be used to probe motion detection field 110B, and the wireless communication link between wireless communication device 102A and wireless communication device 102B can be used to probe motion detection field 110C. In some instances, each wireless communication device 102 detects motion in motion detection fields 110 accessed by that device by processing received signals that are based on wireless signals transmitted by wireless communication devices 102 through motion detection fields 110. For example, when person 106 shown in FIG. 1 moves in motion detection field 110A and motion detection field 110C, wireless communication devices 102 may detect the motion based on signals they received that are based on wireless signals transmitted through respective motion detection fields 110. For instance, wireless communication device 102A can detect motion of person 106 in motion detection fields 110A, 110C, wireless communication device 102B can detect motion of person 106 in motion detection field 110C, and wireless communication device 102C can detect motion of person 106 in motion detection field 110A.

In some instances, motion detection fields 110 can include, for example, air, solid materials, liquids, or another medium through which wireless electromagnetic signals may propagate. In the example shown in FIG. 1, motion detection field 110A provides a wireless communication channel between wireless communication device 102A and wireless communication device 102C, motion detection field 110B provides a wireless communication channel between wireless communication device 102B and wireless communication device 102C, and motion detection field 110C provides a wireless communication channel between wireless communication device 102A and wireless communication device 102B. In some aspects of operation, wireless signals transmitted on a wireless communication channel (separate from or shared with the wireless communication channel for network traffic) are used to detect movement of an object in a space. The objects can be any type of static or moveable object and can be living or inanimate. For example, the object can be a human (e.g., person 106 shown in FIG. 1), an animal, an inorganic object, or another device, apparatus, or assembly, an object that defines all or part of the boundary of a space (e.g., a wall, door, window, etc.), or another type of object. In some implementations, motion information from the wireless communication devices may be analyzed to determine a location of the detected motion. For example, as described further below, one of wireless communication devices 102 (or another device communicably coupled to wireless communications devices 102) may determine that the detected motion is nearby a particular wireless communication device.

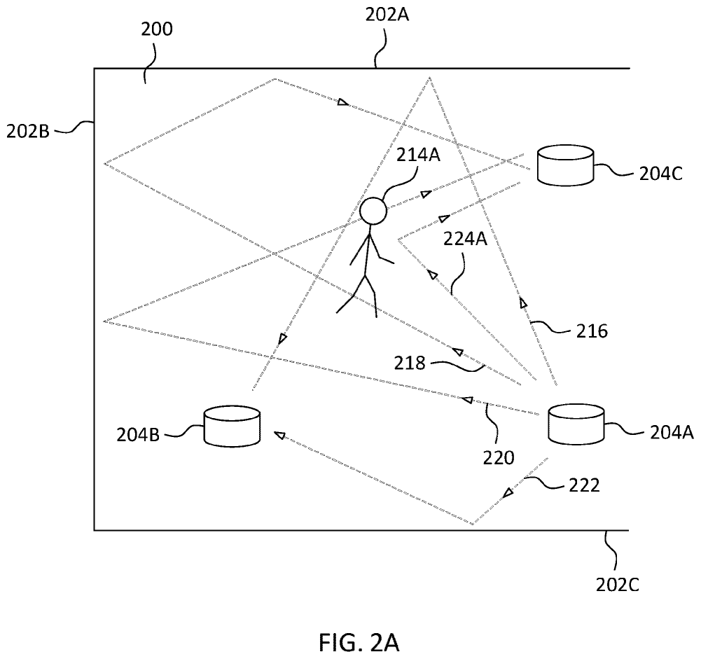

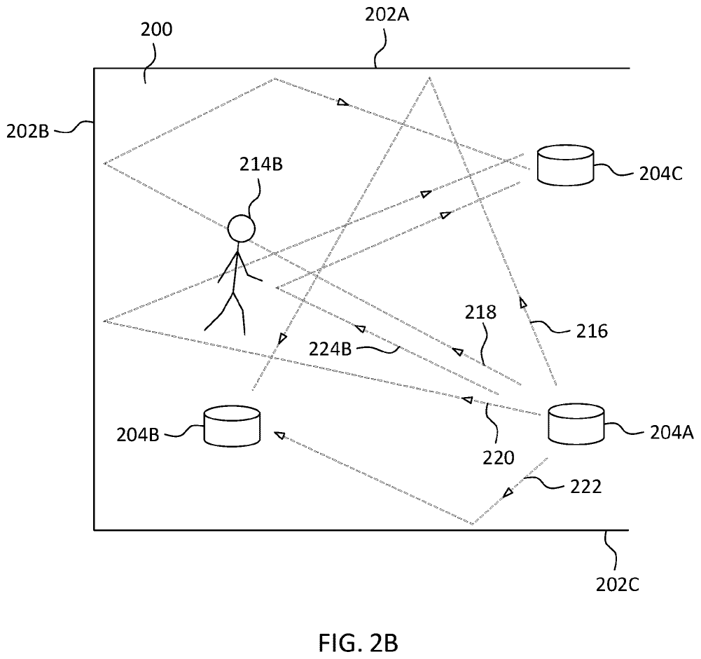

FIG. 2A and FIG. 2B are diagrams showing example wireless signals communicated between wireless communication devices 204A, 204B, 204C. Wireless communication devices 204A, 204B, 204C can be, for example, wireless communication devices 102A, 102B, 102C shown in FIG. 1, or other types of wireless communication devices. Wireless communication devices 204A, 204B, 204C transmit wireless signals through space 200. Space 200 can be completely or partially enclosed or open at one or more boundaries. In an example, space 200 may be a sensing space. Space 200 can be or can include an interior of a room, multiple rooms, a building, an indoor area, outdoor area, or the like. First wall 202A, second wall 202B, and third wall 202C at least partially enclose space 200 in the example shown.

In the example shown in FIG. 2A and FIG. 2B, wireless communication device 204A is operable to transmit wireless signals repeatedly (e.g., periodically, intermittently, at scheduled, unscheduled or random intervals, etc.). Wireless communication devices 204B, 204C are operable to receive signals based on those transmitted by wireless communication device 204A. Wireless communication devices 204B, 204C each have a modem (e.g., modem 112 shown in FIG. 1) that is configured to process received signals to detect motion of an object in space 200.

As shown, an object is in first position 214A in FIG. 2A, and the object has moved to second position 214B in FIG. 2B. In FIG. 2A and FIG. 2B, the moving object in space 200 is represented as a human, but the moving object can be another type of object. For example, the moving object can be an animal, an inorganic object (e.g., a system, device, apparatus, or assembly), an object that defines all or part of the boundary of space 200 (e.g., a wall, door, window, etc.), or another type of object.

As shown in FIG. 2A and FIG. 2B, multiple example paths of the wireless signals transmitted from wireless communication device 204A are illustrated by dashed lines. Along first signal path 216, the wireless signal is transmitted from wireless communication device 204A and reflected off first wall 202A toward the wireless communication device 204B. Along second signal path 218, the wireless signal is transmitted from the wireless communication device 204A and reflected off second wall 202B and first wall 202A toward wireless communication device 204C. Along third signal path 220, the wireless signal is transmitted from the wireless communication device 204A and reflected off second wall 202B toward wireless communication device 204C. Along fourth signal path 222, the wireless signal is transmitted from the wireless communication device 204A and reflected off third wall 202C toward the wireless communication device 204B.

In FIG. 2A, along fifth signal path 224A, the wireless signal is transmitted from wireless communication device 204A and reflected off the object at first position 214A toward wireless communication device 204C. Between FIG. 2A and FIG. 2B, a surface of the object moves from first position 214A to second position 214B in space 200 (e.g., some distance away from first position 214A). In FIG. 2B, along sixth signal path 224B, the wireless signal is transmitted from wireless communication device 204A and reflected off the object at second position 214B toward wireless communication device 204C. Sixth signal path 224B depicted in FIG. 2B is longer than fifth signal path 224A depicted in FIG. 2A due to the movement of the object from first position 214A to second position 214B. In some examples, a signal path can be added, removed, or otherwise modified due to movement of an object in a space.

The example wireless signals shown in FIG. 2A and FIG. 2B may experience attenuation, frequency shifts, phase shifts, or other effects through their respective paths and may have portions that propagate in another direction, for example, through the first, second and third walls 202A, 202B, and 202C. In some examples, the wireless signals are radio frequency (RF) signals. The wireless signals may include other types of signals.

In the example shown in FIG. 2A and FIG. 2B, wireless communication device 204A can repeatedly transmit a wireless signal. In particular, FIG. 2A shows the wireless signal being transmitted from wireless communication device 204A at a first time, and FIG. 2B shows the same wireless signal being transmitted from wireless communication device 204A at a second, later time. The transmitted signal can be transmitted continuously, periodically, at random or intermittent times or the like, or a combination thereof. The transmitted signal can have a number of frequency components in a frequency bandwidth. The transmitted signal can be transmitted from wireless communication device 204A in an omnidirectional manner, in a directional manner or otherwise. In the example shown, the wireless signals traverse multiple respective paths in space 200, and the signal along each path may become attenuated due to path losses, scattering, reflection, or the like and may have a phase or frequency offset.

As shown in FIG. 2A and FIG. 2B, the signals from first to sixth paths 216, 218, 220, 222, 224A, and 224B combine at wireless communication device 204C and wireless communication device 204B to form received signals. Because of the effects of the multiple paths in space 200 on the transmitted signal, space 200 may be represented as a transfer function (e.g., a filter) in which the transmitted signal is input and the received signal is output. When an object moves in space 200, the attenuation or phase offset affected upon a signal in a signal path can change, and hence, the transfer function of space 200 can change. Assuming the same wireless signal is transmitted from wireless communication device 204A, if the transfer function of space 200 changes, the output of that transfer function—the received signal—will also change. A change in the received signal can be used to detect movement of an object.

Mathematically, a transmitted signal f(t) transmitted from the first wireless communication device 204A may be described according to Equation (1):

$$f ( t ) = {\sum }_{n = - ∞}^{∞} {c}_{n} {e}^{j {ω}_{n} t} \qquad ( 1 )$$

Where ωₙ represents the frequency of nth frequency component of the transmitted signal, cₙ represents the complex coefficient of the nth frequency component, and t represents time. With the f(t) being transmitted from the first wireless communication device 204A, an output signal rₖ(t) from a path, k, may be described according to Equation (2):

$${r}_{k} ( t ) = {\sum }_{n = - ∞}^{∞} {α}_{n , k} {c}_{n} {e}^{j ( {ω}_{n} t + {ϕ}_{n , k} )} \qquad ( 2 )$$

Where α_{n,k} represents an attenuation factor (or channel response; e.g., due to scattering, reflection, and path losses) for the nth frequency component along k, and ϕ_{n,k} represents the phase of the signal for nth frequency component along k. Then, the received signal, R, at a wireless communication device can be described as the summation of all output signals rₖ(t) from all paths to the wireless communication device, which is shown in Equation (3):

$$R = {\sum }_{k} {r}_{k} ( t ) \qquad ( 3 )$$

Substituting Equation (2) into Equation (3) renders the following Equation (4):

$$R = {\sum }_{k} {\sum }_{n = - ∞}^{∞} ( {α}_{n , k} {e}^{j {ϕ}_{n , k}} ) {c}_{n} {e}^{j {ω}_{n} t} \qquad ( 4 )$$

R at a wireless communication device can then be analyzed. R at a wireless communication device can be transformed to the frequency domain, for example, using a fast Fourier transform (FFT) or another type of algorithm. The transformed signal can represent R as a series of n complex values, one for each of the respective frequency components (at the n frequencies ωₙ). For a frequency component at frequency ωₙ, a complex value, Hₙ, may be represented as follows in Equation (5):

$${H}_{n} = {\sum }_{k} {c}_{n} {α}_{n , k} {e}^{j {ϕ}_{n , k}} \qquad ( 5 )$$

Hₙ for a given ωₙ indicates a relative magnitude and phase offset of the received signal at ωₙ. When an object moves in the space, Hₙ changes due to α_{n,k} of the space changing. Accordingly, a change detected in the channel response can be indicative of movement of an object within the communication channel. In some instances, noise, interference, or other phenomena can influence the channel response detected by the receiver, and the motion detection system can reduce or isolate such influences to improve the accuracy and quality of motion detection capabilities. In some implementations, the overall channel response can be represented as follows in Equation (6):

$${h}_{ch} = {\sum }_{k} {\sum }_{n = - ∞}^{∞} {α}_{n , k} \qquad ( 6 )$$

In some instances, the channel response, h_{ch}, for a space can be determined, for example, based on the mathematical theory of estimation. For instance, a reference signal, R_{ef}, can be modified with candidate h_{ch}, and then a maximum likelihood approach can be used to select the candidate channel which gives best match to the received signal (R_{cvd}). In some cases, an estimated received signal (\hat{R}_{cvd}) is obtained from the convolution of R_{ef} with the candidate h_{ch}, and then the channel coefficients of h_{ch} are varied to minimize the squared error of \hat{R}_{cvd}. This can be mathematically illustrated as follows in Equation (7):

$${R}_{cvd} = {R}_{ef} ⊗ {h}_{ch} = {\sum }_{k = - 𝔪}^{𝔪} {R}_{ef} ( n - k ) {h}_{ch} ( k ) \qquad ( 7 )$$

with the optimization criterion

$${min}_{{h}_{ch}} \{ \sum {( {\hat{R}}_{cvd} - {R}_{cvd} )}^{2} \}$$

The minimizing, or optimizing, process can utilize an adaptive filtering technique, such as least mean squares (LMS), recursive least squares (RLS), batch least squares (BLS), etc. The channel response can be a finite impulse response (FIR) filter, infinite impulse response (IIR) filter, or the like. As shown in the equation above, the received signal can be considered as a convolution of the reference signal and the channel response. The convolution operation means that the channel coefficients possess a degree of correlation with each of the delayed replicas of the reference signal. The convolution operation as shown in the equation above, therefore shows that the received signal appears at different delay points, each delayed replica being weighted by the channel coefficient.

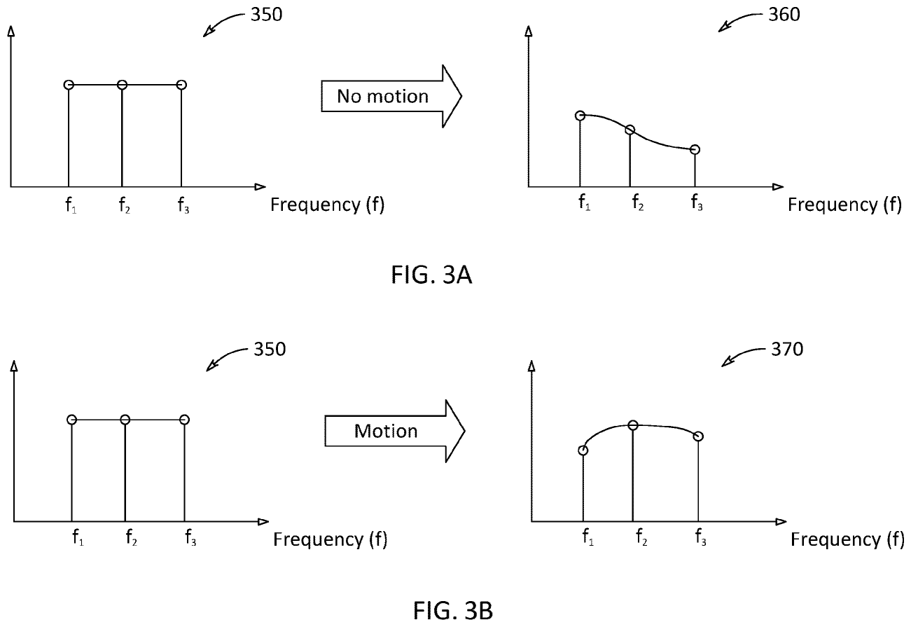

FIG. 3A and FIG. 3B are plots showing examples of channel responses 360, 370 computed from the wireless signals communicated between wireless communication devices 204A, 204B, 204C in FIG. 2A and FIG. 2B. FIG. 3A and FIG. 3B also show frequency domain representation 350 of an initial wireless signal transmitted by wireless communication device 204A. In the examples shown, channel response 360 in FIG. 3A represents the signals received by wireless communication device 204B when there is no motion in space 200, and channel response 370 in FIG. 3B represents the signals received by wireless communication device 204B in FIG. 2B after the object has moved in space 200.

In the example shown in FIG. 3A and FIG. 3B, for illustration purposes, wireless communication device 204A transmits a signal that has a flat frequency profile (the magnitude of each frequency component, f₁, f₂ and f₃ is the same), as shown in frequency domain representation 350. Because of the interaction of the signal with space 200 (and the objects therein), the signals received at wireless communication device 204B that are based on the signal sent from wireless communication device 204A are different from the transmitted signal. In this example, where the transmitted signal has a flat frequency profile, the received signal represents the channel response of space 200. As shown in FIG. 3A and FIG. 3B, channel responses 360, 370 are different from frequency domain representation 350 of the transmitted signal. When motion occurs in space 200, a variation in the channel response will also occur. For example, as shown in FIG. 3B, channel response 370 that is associated with motion of object in space 200 varies from channel response 360 that is associated with no motion in space 200.

Furthermore, as an object moves within space 200, the channel response may vary from channel response 370. In some cases, space 200 can be divided into distinct regions and the channel responses associated with each region may share one or more characteristics (e.g., shape), as described below. Thus, motion of an object within different distinct regions can be distinguished, and the location of detected motion can be determined based on an analysis of channel responses.

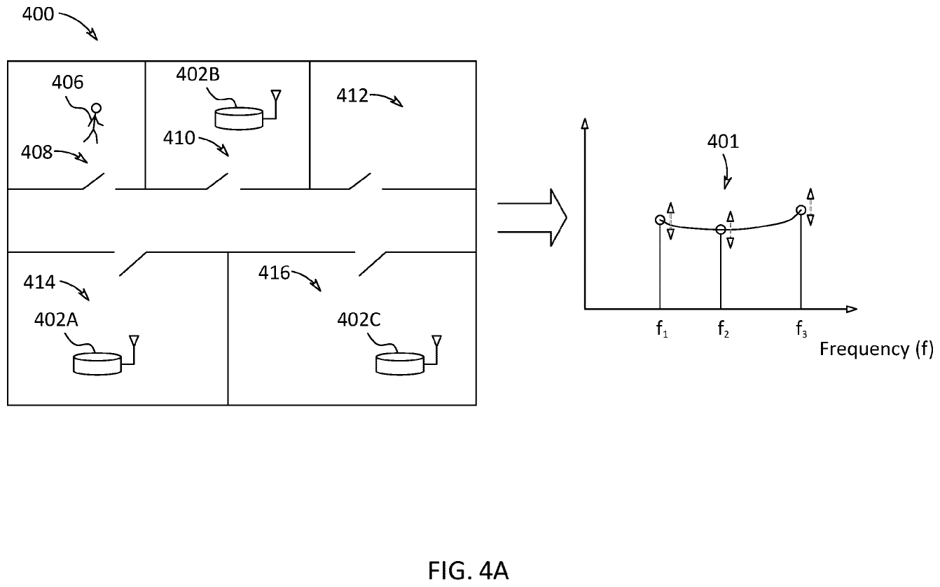

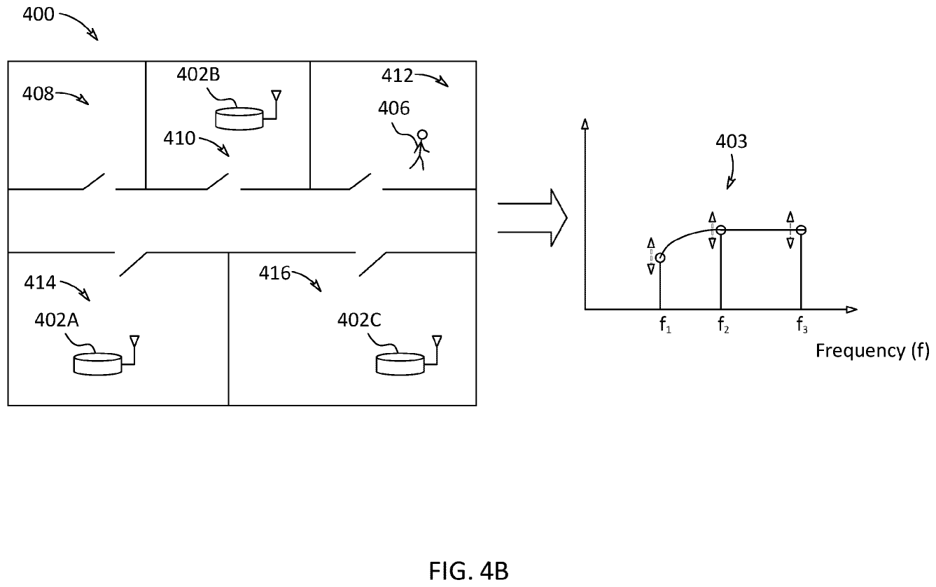

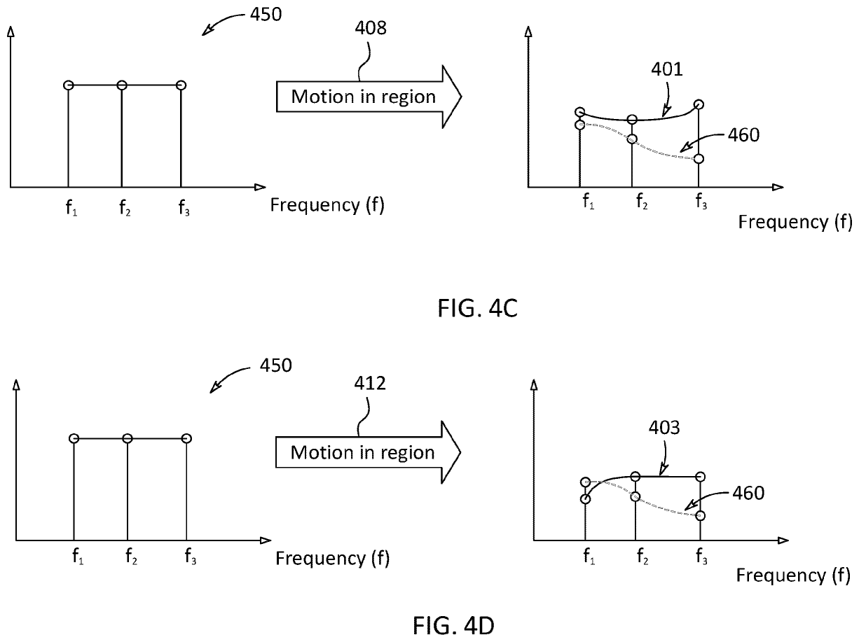

FIG. 4A and FIG. 4B are diagrams showing example channel responses 401, 403 associated with motion of object 406 in distinct regions 408, 412 of space 400. In the examples shown, space 400 is a building, and space 400 is divided into a plurality of distinct regions-first region 408, second region 410, third region 412, fourth region 414, and fifth region 416. Space 400 may include additional or fewer regions, in some instances. As shown in FIG. 4A and FIG. 4B, the regions within space 400 may be defined by walls between rooms. In addition, the regions may be defined by ceilings between floors of a building. For example, space 400 may include additional floors with additional rooms. In addition, in some instances, the plurality of regions of a space can be or include a number of floors in a multistory building, a number of rooms in the building, or a number of rooms on a particular floor of the building. In the example shown in FIG. 4A, an object located in first region 408 is represented as person 406, but the moving object can be another type of object, such as an animal or an inorganic object.

In the example shown, wireless communication device 402A is located in fourth region 414 of space 400, wireless communication device 402B is located in second region 410 of space 400, and wireless communication device 402C is located in fifth region 416 of space 400. Wireless communication devices 402 can operate in the same or similar manner as wireless communication devices 102 of FIG. 1. For instance, wireless communication devices 402 may be configured to transmit and receive wireless signals and detect whether motion has occurred in space 400 based on the received signals. As an example, wireless communication devices 402 may periodically or repeatedly transmit motion probe signals through space 400, and receive signals based on the motion probe signals. Wireless communication devices 402 can analyze the received signals to detect whether an object has moved in space 400, such as, for example, by analyzing channel responses associated with space 400 based on the received signals. In addition, in some implementations, wireless communication devices 402 can analyze the received signals to identify a location of detected motion within space 400. For example, wireless communication devices 402 can analyze characteristics of the channel response to determine whether the channel responses share the same or similar characteristics to channel responses known to be associated with first to fifth regions 408, 410, 412, 414, 416 of space 400.

In the examples shown, one (or more) of wireless communication devices 402 repeatedly transmits a motion probe signal (e.g., a reference signal) through space 400. The motion probe signals may have a flat frequency profile in some instances, wherein the magnitude of f₁, f₂ and f₃ is the same or nearly the same. For example, the motion probe signals may have a frequency response similar to frequency domain representation 350 shown in FIG. 3A and FIG. 3B. The motion probe signals may have a different frequency profile in some instances. Because of the interaction of the reference signal with space 400 (and the objects therein), the signals received at another wireless communication device 402 that are based on the motion probe signal transmitted from the other wireless communication device 402 are different from the transmitted reference signal.

Based on the received signals, wireless communication devices 402 can determine a channel response for space 400. When motion occurs in distinct regions within the space, distinct characteristics may be seen in the channel responses. For example, while the channel responses may differ slightly for motion within the same region of space 400, the channel responses associated with motion in distinct regions may generally share the same shape or other characteristics. For instance, channel response 401 of FIG. 4A represents an example channel response associated with motion of object 406 in first region 408 of space 400, while channel response 403 of FIG. 4B represents an example channel response associated with motion of object 406 in third region 412 of space 400. Channel responses 401, 403 are associated with signals received by the same wireless communication device 402 in space 400.

FIG. 4C and FIG. 4D are plots showing channel responses 401, 403 of FIG. 4A and FIG. 4B overlaid on channel response 460 associated with no motion occurring in space 400. When motion occurs in space 400, a variation in the channel response will occur relative to channel response 460 associated with no motion, and thus, motion of an object in space 400 can be detected by analyzing variations in the channel responses. In addition, a relative location of the detected motion within space 400 can be identified. For example, the shape of channel responses associated with motion can be compared with reference information (e.g., using a trained artificial intelligence (AI) model) to categorize the motion as having occurred within a distinct region of space 400.

When there is no motion in space 400 (e.g., when object 406 is not present), wireless communication device 402 may compute channel response 460 associated with no motion. Slight variations may occur in the channel response due to a number of factors; however, multiple channel responses 460 associated with different periods of time may share one or more characteristics. In the example shown, channel response 460 associated with no motion has a decreasing frequency profile (the magnitude of each of f₁, f₂ and f₃ is less than the previous). The profile of channel response 460 may differ in some instances (e.g., based on different room layouts or placement of wireless communication devices 402).

When motion occurs in space 400, a variation in the channel response will occur. For instance, in the examples shown in FIG. 4C and FIG. 4D, channel response 401 associated with motion of object 406 in first region 408 differs from channel response 460 associated with no motion and channel response 403 associated with motion of object 406 in third region 412 differs from channel response 460 associated with no motion. Channel response 401 has a concave-parabolic frequency profile (the magnitude of the middle frequency component, f₂, is less than the outer frequency components f1 and f3), while channel response 403 has a convex-asymptotic frequency profile (the magnitude of the middle frequency component f2 is greater than the outer frequency components, f₁ and f₃). The profiles of channel responses 401, 403 may differ in some instances (e.g., based on different room layouts or placement of the wireless communication devices 402).

Analyzing channel responses may be considered similar to analyzing a digital filter. A channel response may be formed through the reflections of objects in a space as well as reflections created by a moving or static human. When a reflector (e.g., a human) moves, it changes the channel response. This may translate to a change in equivalent taps of a digital filter, which can be thought of as having poles and zeros (poles amplify the frequency components of a channel response and appear as peaks or high points in the response, while zeros attenuate the frequency components of a channel response and appear as troughs, low points, or nulls in the response). A changing digital filter can be characterized by the locations of its peaks and troughs, and a channel response may be characterized similarly by its peaks and troughs. For example, in some implementations, analyzing nulls and peaks in the frequency components of a channel response (e.g., by marking their location on the frequency axis and their magnitude), motion can be detected.

In some implementations, a time series aggregation can be used to detect motion. A time series aggregation may be performed by observing the features of a channel response over a moving window and aggregating the windowed result by using statistical measures (e.g., mean, variance, principal components, etc.). During instances of motion, the characteristic digital-filter features would be displaced in location and flip-flop between some values due to the continuous change in the scattering scene. That is, an equivalent digital filter exhibits a range of values for its peaks and nulls (due to the motion). By looking this range of values, unique profiles (in examples profiles may also be referred to as signatures) may be identified for distinct regions within a space.

In some implementations, an AI model may be used to process data. AI models may be of a variety of types, for example linear regression models, logistic regression models, linear discriminant analysis models, decision tree models, naïve bayes models, K-nearest neighbors models, learning vector quantization models, support vector machines, bagging and random forest models, and deep neural networks. In general, all AI models aim to learn a function which provides the most precise correlation between input values and output values and are trained using historic sets of inputs and outputs that are known to be correlated. In examples, artificial intelligence may also be referred to as machine learning.

In some implementations, the profiles of the channel responses associated with motion in distinct regions of space 400 can be learned. For example, machine learning may be used to categorize channel response characteristics with motion of an object within distinct regions of a space. In some cases, a user associated with wireless communication devices 402 (e.g., an owner or other occupier of space 400) can assist with the learning process. For instance, referring to the examples shown in FIG. 4A and FIG. 4B, the user can move in each of first to fifth regions 408, 410, 412, 414, 416 during a learning phase and may indicate (e.g., through a user interface on a mobile computing device) that he/she is moving in one of the particular regions in space 400. For example, while the user is moving through first region 408 (e.g., as shown in FIG. 4A) the user may indicate on a mobile computing device that he/she is in first region 408 (and may name the region as “bedroom”, “living room”, “kitchen”, or another type of room of a building, as appropriate). Channel responses may be obtained as the user moves through the region, and the channel responses may be “tagged” with the user's indicated location (region). The user may repeat the same process for the other regions of space 400. The term “tagged” as used herein may refer to marking and identifying channel responses with the user's indicated location or any other information.

The tagged channel responses can then be processed (e.g., by machine learning software) to identify unique characteristics of the channel responses associated with motion in the distinct regions. Once identified, the identified unique characteristics may be used to determine a location of detected motion for newly computed channel responses. For example, an AI model may be trained using the tagged channel responses, and once trained, newly computed channel responses can be input to the AI model, and the AI model can output a location of the detected motion. For example, in some cases, mean, range, and absolute values are input to an AI model. In some instances, magnitude and phase of the complex channel response itself may be input as well. These values allow the AI model to design arbitrary front-end filters to pick up the features that are most relevant to making accurate predictions with respect to motion in distinct regions of a space. In some implementations, the AI model is trained by performing a stochastic gradient descent. For instance, channel response variations that are most active during a certain zone may be monitored during the training, and the specific channel variations may be weighted heavily (by training and adapting the weights in the first layer to correlate with those shapes, trends, etc.). The weighted channel variations may be used to create a metric that activates when a user is present in a certain region.

For extracted features like channel response nulls and peaks, a time-series (of the nulls/peaks) may be created using an aggregation within a moving window, taking a snapshot of few features in the past and present, and using that aggregated value as input to the network. Thus, the network, while adapting its weights, will be trying to aggregate values in a certain region to cluster them, which can be done by creating a logistic classifier based decision surfaces. The decision surfaces divide different clusters, and subsequent layers can form categories based on a single cluster or a combination of clusters.

In some implementations, an AI model includes two or more layers of inference. The first layer acts as a logistic classifier which can divide different concentrations of values into separate clusters, while the second layer combines some of these clusters together to create a category for a distinct region. Additionally, subsequent layers can help in extending the distinct regions over more than two categories of clusters. For example, a fully-connected AI model may include an input layer corresponding to the number of features tracked, a middle layer corresponding to the number of effective clusters (through iterating between choices), and a final layer corresponding to different regions. Where complete channel response information is input to the AI model, the first layer may act as a shape filter that can correlate certain shapes. Thus, the first layer may lock to a certain shape, the second layer may generate a measure of variation happening in those shapes, and third and subsequent layers may create a combination of those variations and map them to different regions within the space. The output of different layers may then be combined through a fusing layer.

### B. Wi-Fi Sensing System Example Methods and Apparatus

Section B describes systems and methods that are useful for a wireless sensing system configured to send sensing transmissions and make sensing measurements.

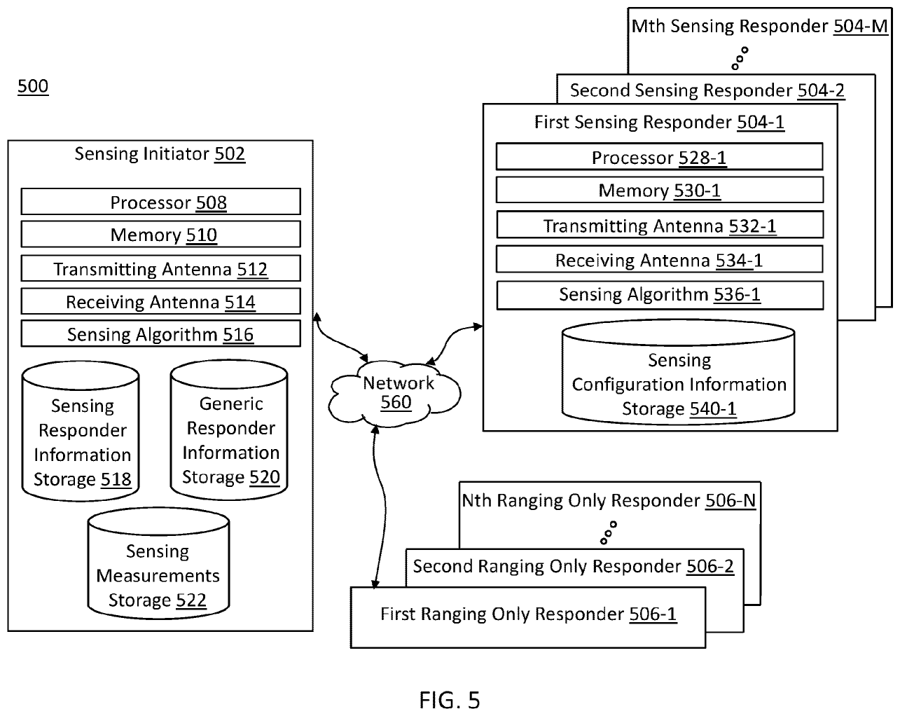

FIG. 5 depicts an implementation of some of an architecture of an implementation of system 500 for Wi-Fi sensing, according to some embodiments.

System 500 may include a plurality of networking devices. In an implementation, the plurality of networking devices may include sensing initiator 502, plurality of sensing responders 504-(1-M), and plurality of ranging only responders 506-(1-N). Further, system 500 may include network 560 enabling communication between the system components for information exchange. System 500 may be an example or instance of wireless communication system 100, and network 560 may be an example or instance of wireless network or cellular network, details of which are provided with reference to FIG. 1 and its accompanying description. In examples, plurality of sensing responders 504-(1-M) may include at least first sensing responder 504-1 and second sensing responder 504-2. Similarly, plurality of ranging only responders 506-(1-N) may include at least first ranging only responder 506-1 and second ranging only responder 506-2. Further, in examples, sensing initiator 502 may be an access point (AP) and plurality of sensing responders 504-(1-M) may be stations (STAs) associated with the sensing initiator 502. In some embodiments, one or more of the plurality of sensing responders 504-(1-M) may not be associated (i.e., may be unassociated) with sensing initiator 502.

According to an embodiment, sensing initiator 502 may be configured to receive a sensing transmission (for example, from one or more of plurality of sensing responders 504-(1-M)) and perform one or more measurements (for example, channel state information) useful for Wi-Fi sensing. These measurements may be known as sensing measurements. The sensing measurements may be processed to achieve a sensing result of system 500, such as detecting motions or gestures. In some embodiments, sensing initiator 502 may be a STA. According to an implementation, sensing initiator 502 may be a sensing receiver.

According to an implementation, sensing initiator 502 may be implemented by a device, such as wireless communication device 102 shown in FIG. 1. In some implementations, sensing initiator 502 may be implemented by a device, such as wireless communication device 204 shown in FIG. 2A and FIG. 2B. Further, sensing initiator 502 may be implemented by a device, such as wireless communication device 402 shown in FIG. 4A and FIG. 4B. In some embodiments, sensing initiator 502 may be any computing device, such as a desktop computer, a laptop, a tablet computer, a mobile device, a personal digital assistant (PDA), or any other computing device. According to an implementation, sensing initiator 502 may be enabled to control a sensing measurement session to ensure that required sensing transmissions are made at a required time and to ensure an accurate determination of sensing measurements. In some embodiments, sensing initiator 502 may process sensing measurements to achieve a sensing result of system 500. In some embodiments, sensing initiator 502 may be configured to transmit sensing measurements to one or more of a plurality of sensing responders 504-(1-M), and one or more of the plurality of sensing responders 504-(1-M) may be configured to process the sensing measurements to achieve a sensing result of system 500.

Referring again to FIG. 5, in some embodiments, first sensing responder 504-1 may form a part of a basic service set (BSS) and may be configured to send a sensing transmission to sensing initiator 502 based on which one or more sensing measurements (for example, channel state information) may be performed for Wi-Fi sensing. In an embodiment, first sensing responder 504-1 may be a STA. In some embodiments, first sensing responder 504-1 may be an AP. According to an implementation, first sensing responder 504-1 may be implemented by a device, such as wireless communication device 102 shown in FIG. 1. In some implementations, first sensing responder 504-1 may be implemented by a device, such as wireless communication device 204 shown in FIG. 2A and FIG. 2B. Further, first sensing responder 504-1 may be implemented by a device, such as wireless communication device 402 shown in FIG. 4A and FIG. 4B. In some embodiments, first sensing responder 504-1 may be any computing device, such as a desktop computer, a laptop, a tablet computer, a mobile device, a PDA, or any other computing device. In some implementations, communication between sensing initiator 502 and first sensing responder 504-1 may happen via station management entity (SME) and MAC layer management entity (MLME) protocols. According to an implementation, first sensing responder 504-1 may be a sensing transmitter.

According to an embodiment, first ranging only responder 506-1 may be configured to send a non-sensing transmission to sensing initiator 502, for example, for a ranging procedure. According to an implementation, first ranging only responder 506-1 may be implemented by a device, such as wireless communication device 102 shown in FIG. 1. In some implementations, first ranging only responder 506-1 may be implemented by a device, such as wireless communication device 204 shown in FIG. 2A and FIG. 2B. Further, first ranging only responder 506-1 may be implemented by a device, such as wireless communication device 402 shown in FIG. 4A and FIG. 4B. In some embodiments, first ranging only responder 506-1 may be any computing device, such as a desktop computer, a laptop, a tablet computer, a mobile device, a PDA, or any other computing device.

Referring to FIG. 5, in more detail, sensing initiator 502 may include processor 508 and memory 510. For example, processor 508 and memory 510 of sensing initiator 502 may be processor 114 and memory 116, respectively, as shown in FIG. 1. In an embodiment, sensing initiator 502 may further include transmitting antenna(s) 512, receiving antenna(s) 514, and sensing algorithm 516.

In an implementation, sensing algorithm 516 may be responsible for receiving sensing transmissions and associated transmission parameters, calculating sensing measurements, and processing sensing measurements to fulfill a sensing result. In some implementations, receiving sensing transmissions and associated transmission parameters, and calculating sensing measurements may be carried out in the MAC layer of sensing initiator 502, and processing sensing measurements to fulfill a sensing result may be carried out in the application layer of sensing initiator 502. In examples, the algorithm running in the application layer of sensing receiver 502 is known as Wi-Fi sensing agent, sensing application, or sensing algorithm. In some implementations, the algorithm running in the MAC layer of sensing receiver 502 and the algorithm running in the application layer of sensing receiver 502 may run separately on processor 508. In an implementation, sensing algorithm 516 may pass physical layer parameters (e.g., such as channel state information) from the MAC layer of sensing initiator 502 to the application layer of sensing initiator 502 and may use the physical layer parameters to detect one or more features of interest. In an example, the application layer may operate on the physical layer parameters and form services or features, which may be presented to an end-user. According to an implementation, communication between the MAC layer of sensing initiator 502 and other layers or components may take place based on communication interfaces, such as MLME interface and a data interface. According to some implementations, sensing algorithm 516 may include or execute Wi-Fi sensing agent. In an implementation, sensing algorithm 516 may process and analyze sensing measurements and identify one or more features of interest. Further, sensing algorithm 516 may be configured to determine a number and timing of sensing transmissions and sensing measurements for the purpose of Wi-Fi sensing. In some implementations, sensing algorithm 516 may be configured to transmit sensing measurements to first sensing responder 504-1 for further processing.

In an implementation, sensing algorithm 516 may be configured to cause at least one transmitting antenna of transmitting antenna(s) 512 to transmit messages to first sensing responder 504-1. Further, sensing algorithm 516 may be configured to receive, via at least one receiving antenna of receiving antennas(s) 514, messages from first sensing responder 504-1. In an example, sensing algorithm 516 may be configured to make sensing measurements based on one or more sensing transmissions received from first sensing responder 504-1. According to an implementation, sensing algorithm 516 may be configured to process and analyze sensing measurements to identify one or more features of interest.

Referring again to FIG. 5, sensing initiator 502 may include sensing responder information storage 518, generic responder information storage 520, and sensing measurements storage 522. In an implementation, sensing responder information storage 518 may store information related to plurality of sensing responders 504-(1-M). In examples, sensing responder information storage 518 may store information related to bandwidth allocation or resource units (RUS) allocated to plurality of sensing responders 504-(1-M). In some examples, sensing responder information storage 518 may store records for each Association ID (AID)/Ranging session ID (RSID) identifying a sensing responder 504 that is a part of a sensing session. For example, sensing responder information storage 518 may store any requested transmission configuration parameters and/or requested steering matrix configuration parameters or delivered transmission configuration parameters and/or delivered steering matrix configuration parameters associated with an AID/RSID. According to an embodiment, generic responder information storage 520 may store trigger related information that is common to plurality of sensing responders 504-(1-M) and plurality of ranging only responders 506-(1-N). In an implementation, sensing measurements storage 522 may store sensing measurements computed by sensing initiator 502 based on sensing transmissions received from plurality of sensing responders 504-(1-M). Information stored in sensing responder information storage 518, generic responder information storage 520, and sensing measurements storage 522 may be periodically or dynamically updated as required. In an implementation, sensing responder information storage 518, generic responder information storage 520, and sensing measurements storage 522 may include any type or form of storage, such as a database or a file system coupled to memory 510.

Referring again to FIG. 5, first sensing responder 504-1 may include processor 528-1 and memory 530-1. For example, processor 528-1 and memory 530-1 of first sensing responder 504-1 may be processor 114 and memory 116, respectively, as shown in FIG. 1. In an embodiment, first sensing responder 504-1 may further include transmitting antenna(s) 532-1, receiving antenna(s) 534-1, and sensing algorithm 536-1. In an implementation, sensing algorithm 536-1 may be a block that passes physical layer parameters from the MAC of first sensing responder 504-1 to application layer programs. Sensing algorithm 536-1 may be configured to cause at least one transmitting antenna of transmitting antenna(s) 532-1 and at least one receiving antenna of receiving antennas(s) 534-1 to exchange messages with sensing initiator 502.

In an implementation, sensing algorithm 536-1 may be responsible for receiving sensing transmissions and associated transmission parameters, calculating sensing measurements, and/or processing sensing measurements to fulfill a sensing result. In some implementations, receiving sensing transmissions and associated transmission parameters, and calculating sensing measurements and/or processing sensing measurements may be carried out in the MAC layer of first sensing responder 504-1, and processing sensing measurements to fulfill a sensing result may be carried out in the application layer of first sensing responder 504-1. In an implementation, sensing algorithm 536-1 may pass physical layer parameters (e.g., such as channel state information) from the MAC layer of first sensing responder 504-1 to the application layer of sensing responder 504-1 and may use the physical layer parameters to detect one or more features of interest. In an example, the application layer may operate on the physical layer parameters and form services or features, which may be presented to an end-user. According to an implementation, communication between the MAC layer of first sensing responder 504-1 and other layers or components may take place based on communication interfaces, such as MLME interface and a data interface. In an implementation, sensing algorithm 536-1 may process and analyze sensing measurements and identify one or more features of interest. Further, sensing algorithm 536-1 may be configured to determine a number and timing of sensing transmissions and sensing measurements for the purpose of Wi-Fi sensing.

In some embodiments, an antenna may be used to both transmit and receive in a half-duplex format. When the antenna is transmitting, it may be referred to as transmitting antenna 512/532-1, and when the antenna is receiving, it may be referred to as receiving antenna 514/534-1. It is understood by a person of normal skill in the art that the same antenna may be transmitting antenna 512/532-1 in some instances and receiving antenna 514/534-1 in other instances. In the case of an antenna array, one or more antenna elements may be used to transmit or receive a signal, for example, in a beamforming environment. In some examples, a group of antenna elements used to transmit a composite signal may be referred to as transmitting antenna 512/532-1, and a group of antenna elements used to receive a composite signal may be referred to as receiving antenna 514/534-1. In some examples, each antenna is equipped with its own transmission and receive paths, which may be alternately switched to connect to the antenna depending on whether the antenna is operating as transmitting antenna 512/532-1 or receiving antenna 514/534-1.

In an embodiment, first sensing responder 504-1 may include sensing configuration information storage 540-1. In examples, sensing configuration information storage 540-1 may store requested transmission configuration delivered by sensing initiator 502 to first sensing responder 504-1 or delivered transmission configuration delivered by first sensing responder 504-1 to sensing initiator 502. Further, sensing configuration information storage 540-1 may store requested steering matrix configuration delivered by sensing initiator 502 to first sensing responder 504-1 or delivered steering matrix configuration delivered by first sensing responder 504-1 to sensing initiator 502. Information stored in sensing configuration information storage 540-1 may be periodically or dynamically updated as required. In an implementation, sensing configuration information storage 540-1 may include any type or form of storage, such as a database or a file system coupled to memory 530-1.

For ease of explanation and understanding, the description provided above is with reference to first sensing responder 504-1 and first ranging only responder 506-1, however, the description is equally applicable to remaining sensing responders 504-(2-M) and remaining ranging only responders 506-(2-N).

According to one or more implementations, communications in network 560 may be governed by one or more of the 802.11 family of standards developed by IEEE. Some example IEEE standards may include IEEE 802.11-2020, IEEE 802.11ax-2021, IEEE 802.11me, IEEE 802.11az, and IEEE 802.11be. IEEE 802.11-2020 and IEEE 802.11ax-2021 are fully-ratified standards whilst IEEE 802.11 me reflects an ongoing maintenance update to the IEEE 802.11-2020 standard and IEEE 802.11be defines the next generation of standard. IEEE 802.11az is an extension of the IEEE 802.11-2020 and IEEE 802.11ax-2021 standards, adding new functionality. In some implementations, communications may be governed by other standards (other or additional IEEE standards or other types of standards). In some embodiments, parts of network 560 which are not required by system 500 to be governed by one or more of the 802.11 family of standards may be implemented by an instance of any type of network, including wireless network or cellular network.

### C. Systems and Methods for UL-OFDMA Wi-Fi Sensing Using Ranging

The present disclosure generally relates to systems and methods for Wi-Fi sensing. In particular, the present disclosure relates to systems and methods for uplink orthogonal frequency division multiple access (UL-OFDMA) Wi-Fi sensing using ranging.

A Wi-Fi sensing system may be configured to detect features of interest in a sensing space. The Wi-Fi sensing system may be a network of Wi-Fi-enabled devices which are part of an IEEE 802.11 network (sometimes referred to as a basic service set (BSS) or extended service set (ESS)). For example, the Wi-Fi sensing system may include sensing transmitters (which may be sensing initiators) and one or more sensing receivers (which may be sensing responders). The features of interest may include motion of objects and motion tracking, presence detection, intrusion detection, gesture recognition, fall detection, breathing rate detection, and other applications. The sensing space may refer to any physical space in which a Wi-Fi sensing system may operate and may include a place of abode, a place of work, a shopping mall, a sports hall or sports stadium, a garden, or any other physical space.

Currently, an IEEE 802.11 physical channel constitutes a number of OFDM tones or carriers depending on the overall bandwidth of the channel and the revision of the specification. For example, 52 data and pilot carriers may be used for a 20 MHz channel bandwidth and 104 data and pilot carriers may be used for a 40 MHz channel bandwidth. A baseband Wi-Fi receiver may calculate a sensing measurement (for example, channel state measurement (CSI)) consisting of a real and imaginary part for each element and the sensing measurement may be passed to a sensing algorithm to determine if there is motion or movement in the sensing space. In examples, motion may be determined in the sensing space by the sensing algorithm by looking for perturbation in the local environment, e.g., on the transmission path between one or more sensing transmitters and one or more sensing receivers.

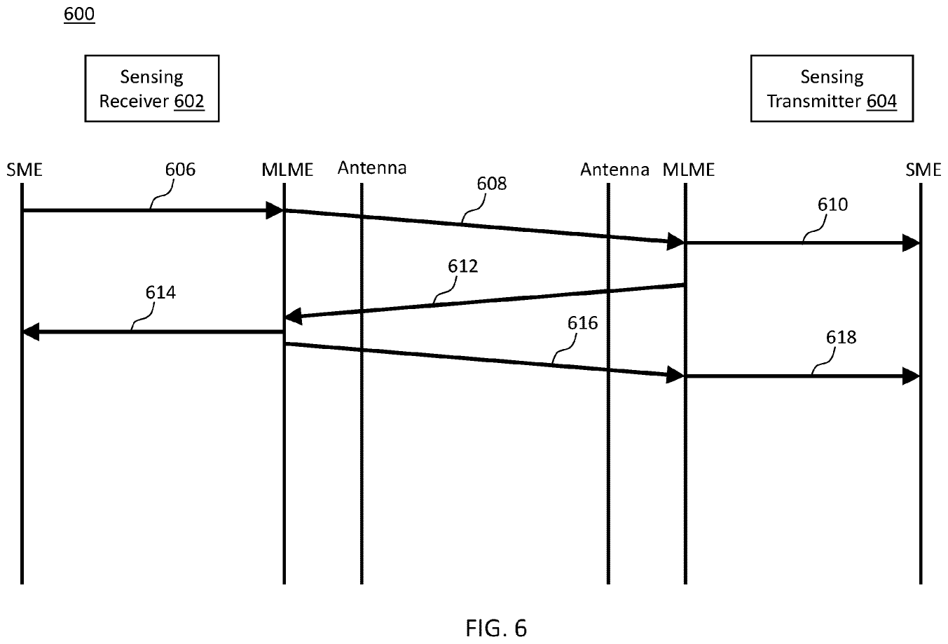

In examples, the process of making a sensing measurement (or a series of sensing measurements) is described by the exchange of transmissions between a sensing transmitter (for example, first sensing responder 504-1) and a sensing receiver (for example, first sensing initiator 502). In an example, after a sensing trigger frame is sent from the sensing receiver to the sensing transmitter, a sensing transmission (which may be referred to a sensing response frame) is sent from the sensing transmitter to the sensing receiver. The sensing transmission may be used by the sensing receiver for making a sensing measurement. In an example, the sensing response frame may be an uplink null data packet (NDP) frame. Process 600 for making a sensing measurement is depicted in FIG. 6, according to some embodiments. At step 606 of process 600, in some implementations, station management entity (SME) of sensing receiver 602 (which is an AP and may be first sensing initiator 502) may send MLME-SENSTRIG.request primitive to MAC layer management entity (MLME) of sensing receiver 602. At step 608 of process 600, in some implementations, MLME of sensing receiver 602 may send a sensing trigger frame to MLME of sensing transmitter 604 (which is a non-AP STA and may be first sensing responder 504-1). At step 610 of process 600, in some implementations, MLME of sensing transmitter 604 may send MLME-SENSTRIG.indication primitive to SME of sensing transmitter 604. At step 612 of process 600, in some implementations, MLME of sensing transmitter 604 may send a sensing response frame to MLME of sensing receiver 602. At step 614 of process 600, in some implementations, MLME of sensing receiver 602 may send MLME-SENSMSG.indication primitive to SME of sensing receiver 602. At step 616 of process 600, in some implementations, MLME of sensing receiver 602 may send an acknowledgement to MLME of sensing transmitter 604. At step 618 of process 600, in some implementations, MLME of sensing transmitter 604 may send MLME-SENSMSG.confirm to SME of sensing transmitter 604.

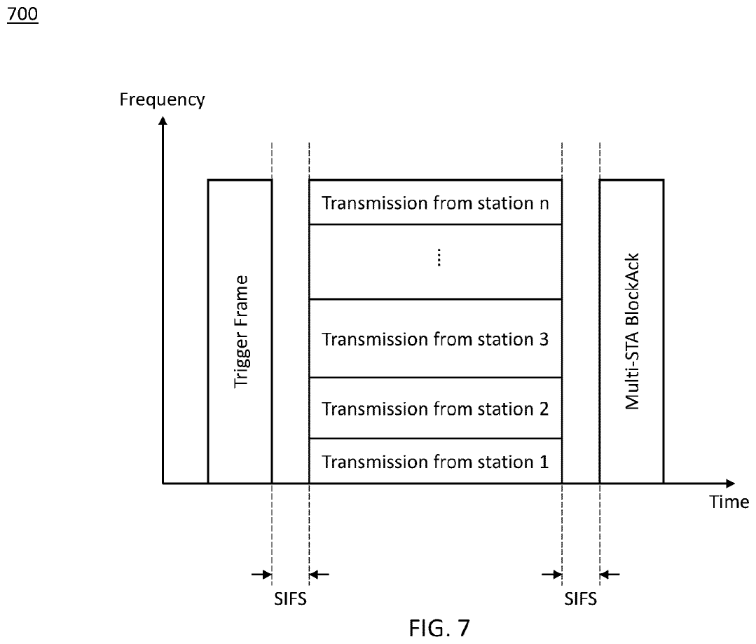

The IEEE 802.11ax amendment (Draft P802.11ax_D8.0) to the IEEE 802.11-2016 specification allows the scheduling and organization of parallel uplink transmissions from multiple STAs using OFDMA. IEEE 802.11 defines a control mechanism for UL-OFDMA based on a trigger frame (Draft P802.11ax_D8.0, § 9.3.1.22). The trigger frame specifies common synchronization parameters to all participating STAs for the transmission opportunity along with a map to the uplink transmission sub-carriers for each responding STA. The map allows the OFDMA to function without clashes or interference. FIG. 7 depicts example 700 of an UL-OFDMA transmission procedure, according to some embodiments. As can be seen in FIG. 7, a transmission (i.e., a sensing transmission which may be a sensing response message) follows the trigger frame after one SIFS. In an example, the duration of SIFS is 10 μs. The main purpose of the trigger frame is to solicit an immediate response of transmissions from n STAs. According to an example, the trigger frame may specify common synchronization parameters to n STAs for the transmission opportunity along with a map to resource units (RUS) for each STA. A message controlled by the trigger frame generally follows a time-frequency message pattern, as shown in FIG. 7.

Currently, a trigger-based Wi-Fi sensing system can enable a sensing receiver (i.e., an AP) to make a sensing measurement on a sensing response frame (which may be an uplink sensing NDP frame) transmitted from a sensing transmitter (i.e., an STA) to the sensing receiver (e.g., uplink from the STA to the AP) but does not enable the sensing receiver to make multiple simultaneous sensing measurements using multiple sensing response frames transmitted from multiple sensing transmitters (e.g., uplink from multiple STAs to the AP) because currently an uplink sensing NDP frame occupies the whole channel bandwidth and UL-OFDMA is not supported for uplink sensing NDP frames.

The present disclosure describes a solution based on 802.11az ranging protocols which uses the downlink (e.g., from an AP to an STA) ranging trigger frame (poll) as a sensing trigger frame and multiple uplink (e.g., from the STA to the AP) poll response frames as the sensing response frames, in place of the sensing NDP frame. The ranging trigger frame (poll) configuration may be used to allocate different uplink OFDMA resource units (RUS) to different sensing transmitters, thereby permitting a sensing receiver to make multiple sensing measurements from multiple sensing transmitters simultaneously. The present disclosure also describes a solution where a single ranging trigger frame (poll) may be sent from a sensing receiver to initiate a ranging procedure with some STAs while initiating a sensing procedure with other STAs, thereby improving overall system efficiency.

The amendment to IEEE standard 802.11 as described in Draft P802.11az_D4.1 adds enhancements for ranging. The enhancements include fine timing measurement (FTM) primitives and timestamps as a part of ranging measurement exchanges. In examples, an FTM session may take place between an initiating station (ISTA) and a responder station (RSTA). Further, in an example, the FTM session may be composed of negotiation, measurements exchange, and termination. The ISTA may use high efficiency (HE) ranging NDPs.

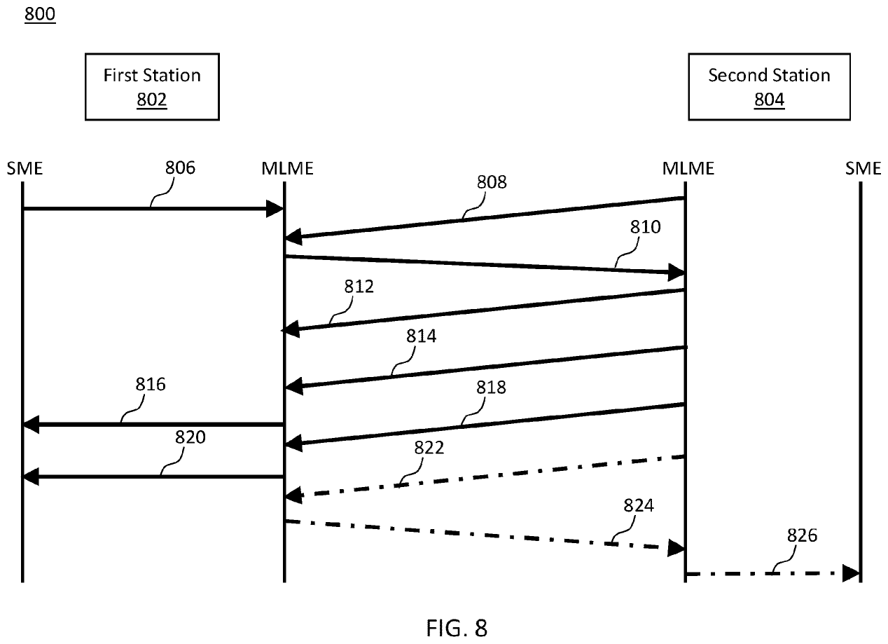

FIG. 8 depicts process 800 illustrating an example of trigger-based (TB) FTM procedure for ranging, according to some embodiments. FIG. 8 is a reproduction of FIG. 6-17c from Draft P802.11az_D4.1. In FIG. 8, first station 802 (which is an RSTA, examples of which are sensing responders 504-1 to 504-M) and second station 804 (which is an ISTA, and example of which is sensing initiator 502) may perform ranging activities related to polling, measurement sounding, and measurement reporting phases. At step 806 of process 800, in some implementations, SME of first station 802 may send MLME-FINETIMINGMSMT.request primitive to MLME of first station 802. At step 808 of process 800, in some implementations, MLME of second station 804 may send trigger frame (poll) to MLME of first station 802. At step 810 of process 800, in some implementations, MLME of first station 802 may send poll response to MLME of second station 804. At step 812 of process 800, in some implementations, MLME of second station 804 may send trigger frame (sounding) to MLME of first station 802. At step 814 of process 800, in some implementations, MLME of second station 804 may send ranging NDP to MLME of first station 802. At step 816 of process 800, in some implementations, MLME of first station 802 may send MLME-FINETIMINGMSMT.confirm primitive to SME of first station 802. At step 818 of process 800, in some implementations, MLME of second station 804 may send R2I LMR feedback (t₂, t₃) to MLME of first station 802. At step 820 of process 800, in some implementations, MLME of first station 802 may send MLME-FINETIMINGMSMT.indication primitive to SME of first station 802. At step 822 of process 800, in some implementations, MLME of second station 804 may send trigger frame (location LMR) to MLME of first station 802. At step 824 of process 800, in some implementations, MLME of first station 802 may send I2R LMR feedback (t₁, t₄) to MLME of second station 804. At step 826 of process 800, in some implementations, MLME of second station 804 may send MLME-FINETIMINGMSMT.indication primitive to SME of second station 804. As shown in FIG. 8, each polling phase may include at least one ranging trigger frame (poll).

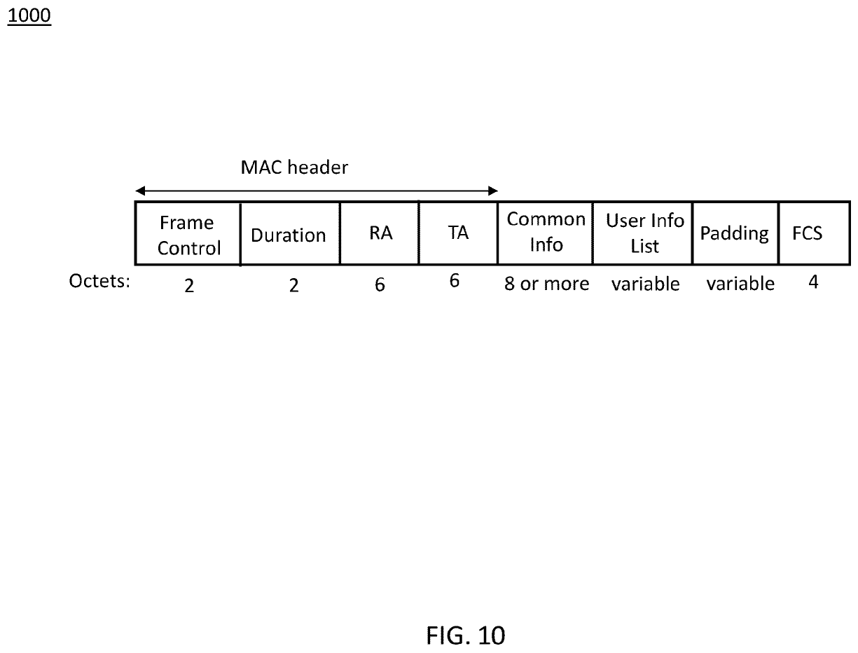

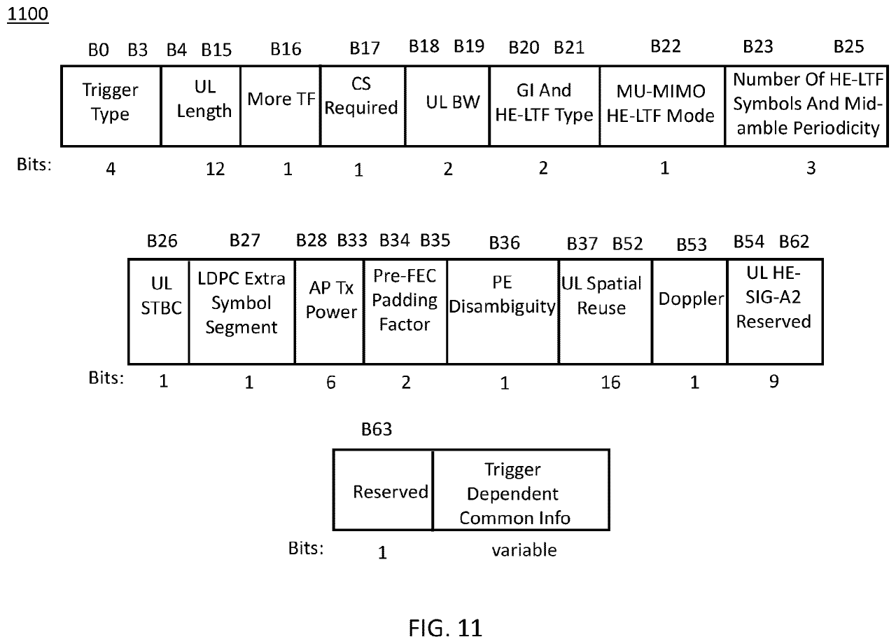

An example of a control format which may be used as a ranging trigger frame (poll) is shown in FIG. 10, where the trigger type is specified as part of the Common Info field, which is described in more detail in the description of FIG. 11. The control frame format of the ranging trigger frame (poll) includes a User Info List field.

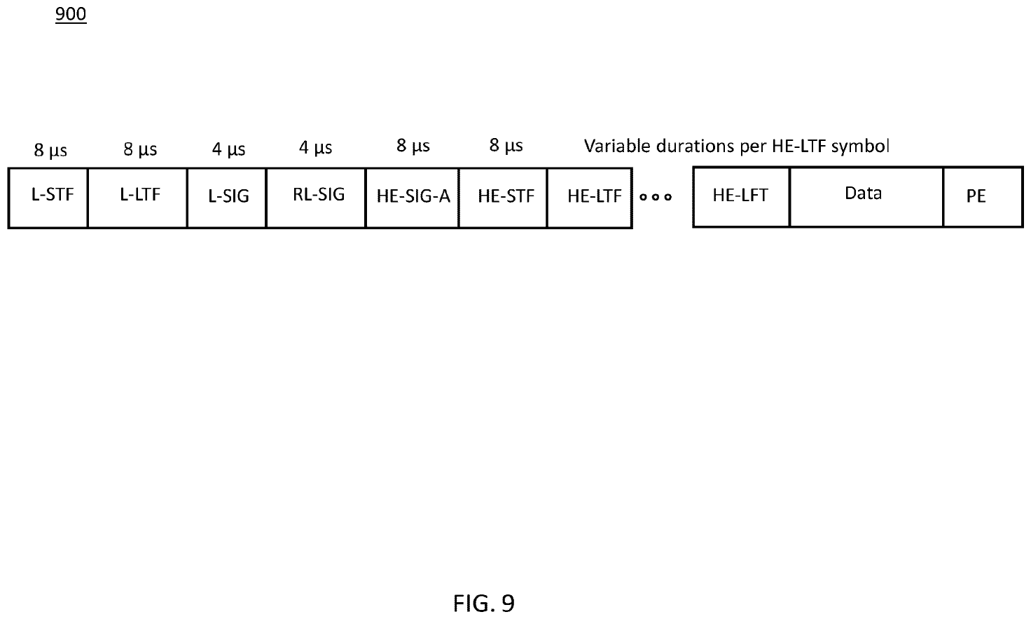

In examples, the ranging trigger frame (poll) may allocate resource units (RUS) to ISTAs. Any ISTA addressed by a User Info List field (which may be referred to as a User Info field) in a ranging trigger frame (poll) may respond with poll response in an S-MPDU within a high efficiency trigger-based physical-layer protocol data unit (HE TB PPDU) in its designated RU allocation. Format 900 of HE TB PPDU is shown in FIG. 9, according to some embodiments. FIG. 9 is a reproduction of FIG. 27-11 of Draft P802.11REVme_D1.1. In examples, based on the poll response, legacy long training field (L-LTF) or high efficiency long training field (HE-LTF) within the preamble on the HE TB PPDU may be used for sensing measurements by a sensing initiator 502 (e.g., an AP or a sensing receiver). As the poll responses for different ISTAs may be allocated different OFDMA RUs, the poll responses may enable a sensing initiator (for example, sensing initiator 502) to make sensing measurements on multiple RUs from multiple sensing responders (for example, sensing responders 504-(1-M)) simultaneously, for example in the same TXOP. The use of sensing transmissions with different RUs enables a system (for example, system 500) to achieve different sensing measurement resolutions from different sensing responders.

FIG. 10 depicts format 1000 of a trigger frame, according to some embodiments. The trigger frame is a control frame on MAC layer. FIG. 10 is a reproduction of FIG. 9-64a of Draft P802.11REVme_D1.1. Further, format 1100 of the Common Info field of the trigger frame is described in FIG. 11. FIG. 11 is a reproduction of FIG. 9-88 of Draft P802.11REVme_D1.1. The Trigger Type subfield of the Common Info field in the trigger frame identifies the Trigger frame variant and its encoding is defined in Table 1 and Table 2 provided below. Table 1 is a reproduction of Table 9-46 of Draft P802.11REVme_D1.1. Table 2 is a reproduction of Table 9-30c from Draft P802.11az_D4.1. The Trigger Type subfield value corresponding to a ranging trigger frame (poll) is eight (8).

TABLE 1
Trigger type subfield of Common Info field

| Trigger Type | |
|---|---|
| subfield value | Trigger frame variant |
| 0 | Basic |
| 1 | Beamforming Report Poll (BFRP) |
| 2 | MU-BAR |
| 3 | MU-RTS |
| 4 | Buffer Status Report Poll (BSRP) |
| 5 | GCR MU-BAR |
| 6 | Bandwidth Query Report Poll (BQRP) |
| 7 | NDP Feedback Report Poll (NFRP) |
| 8-15 | Reserved |

TABLE 2
Trigger type subfield of Common Info field for ranging

| Trigger Type | |
|---|---|
| subfield value | Trigger frame variant |
| 8 | Ranging |
| 9-15 | Reserved |

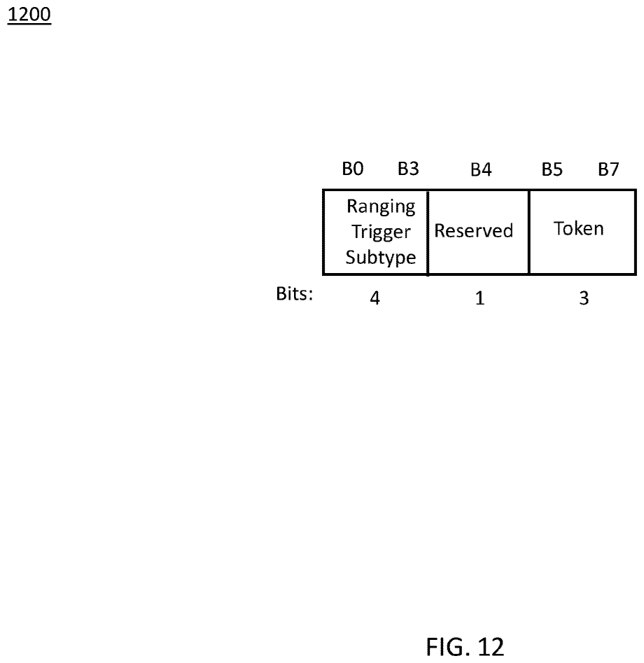

FIG. 12 depicts format 1200 of the Trigger Dependent Common Info subfield of the Common Info field in the trigger frame which identifies the trigger frame variant, according to some embodiments. FIG. 12 is a reproduction of FIG. 9-641a from Draft P802.11az_D4.1. The value of the Ranging Trigger Subtype subfield in the Trigger Dependent Common Info subfield of the Common Info field within ranging trigger frame (poll) is defined in Table 3 provided below. Table 3 is a reproduction of Table 9-30ka in Draft P802.11az_D4.1.

TABLE 3
Ranging Trigger Subtype subfield values

| Ranging Trigger Subtype | |
|---|---|
| subfield value | Ranging Trigger frame subvariant |
| 0 | Poll |
| 1 | Sounding |
| 2 | Secure Sounding |
| 3 | Report |
| 4 | Passive Sounding (#2284, #5006, #5235) |
| 5-15 | Reserved |

In examples, the trigger-based (TB) sensing procedure includes four phases, namely, a polling phase, a UL NDP phase, a DL NDP phase, and a reporting phase. Examples by which the TB polling phase is used for sensing are described in detail below.

According to an implementation, sensing algorithm 516 of sensing initiator 502 may transmit a multiway sensing trigger message to plurality of sensing responders 504-(1-M). In an example, each of plurality of sensing responders 504-(1-M) may support the multiway sensing trigger message. In an implementation, sensing algorithm 516 may transmit the multiway sensing trigger message to plurality of sensing responders 504-(1-M) via transmitting antenna 512. The multiway sensing trigger message may be a new trigger frame type that reuses aspects of the ranging trigger frame (poll). In an implementation, the multiway sensing trigger message may be a sensing polling trigger frame (also referred to as UL-OFDMA sensing trigger frame or UL-OFDMA trigger frame (poll)).

In an example, the multiway sensing trigger message may be configured to request a sensing transmission response from each of plurality of sensing responders 504-(1-M). For example, the multiway sensing trigger message may enable sensing initiator 502 to trigger multiple simultaneous transmissions from plurality of sensing responders 504-(1-M). According to an implementation, in response to receiving the multiway sensing trigger message, each of plurality of sensing responders 504-(1-M) may generate a sensing transmission. In an example, the sensing transmission that the multiway sensing trigger message triggers from each of plurality of sensing responders 504-(1-M) may be a modified poll response.

In an implementation, sensing initiator 502 may receive simultaneously a plurality of sensing transmissions from plurality of sensing responders 504-(1-M) responsive to the multiway sensing trigger message. According to an implementation, sensing initiator 502 may receive the plurality of sensing transmissions via receiving antenna 514 and perform a sensing measurement on at least one of the plurality of sensing transmissions. Accordingly, sensing initiator 502 may perform sensing measurements on multiple uplink modified poll responses in place of sensing NDPs. In an implementation, sensing initiator 502 may identify each of the plurality of sensing transmissions in a different bandwidth allocation. According to an implementation, sensing initiator 502 may receive the plurality of sensing transmissions during a same transmission opportunity period. In some implementations, sensing initiator 502 may receive the plurality of sensing transmissions within a time interval of defined length. In an example, the defined length of a time interval for sensing transmissions to be considered simultaneous may be 5 ms. In some examples, the defined length of a time interval for sensing transmissions to be considered simultaneous may be 7 ms. In an implementation, sensing initiator 502 may receive the plurality of sensing transmissions within one sensing measurement instance.

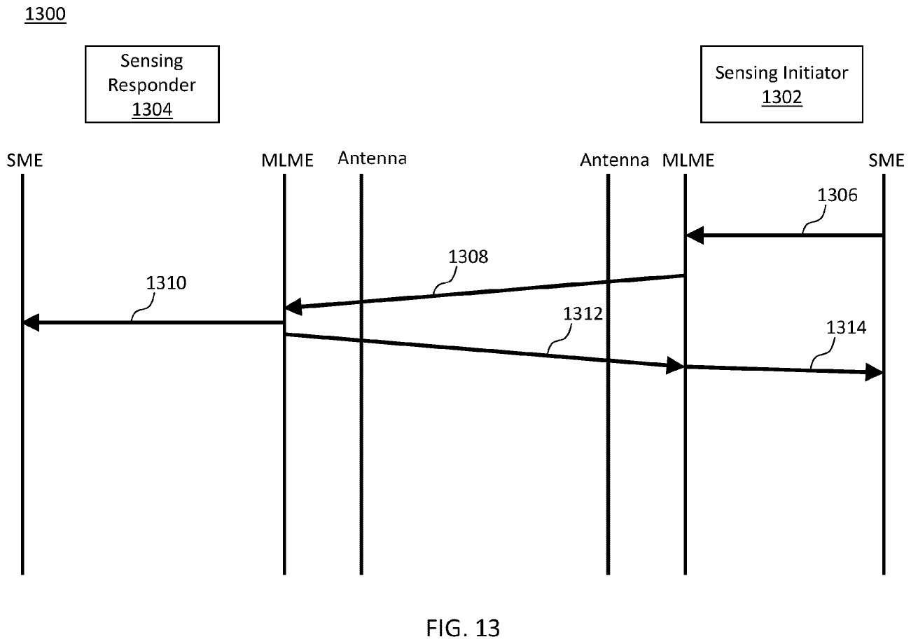

FIG. 13 depicts process 1300 illustrating a multiway sensing trigger message and a modified poll response, according to some embodiments. At step 1306 of process 1300, in some implementations, SME of sensing initiator 1302 (which is an AP or a sensing receiver) may send MLME-SENSTRIG.request primitive to MLME of sensing initiator 1302. At step 1308 of process 1300, in some implementations, MLME of sensing initiator 1302 may send a multiway sensing trigger message to MLME of sensing responder 1304 (which is a STA or a sensing transmitter). At step 1310 of process 1300, in some implementations, MLME of sensing responder 1304 may send MLME-SENSTRIG.indication primitive to SME of sensing responder 1304. At step 1312 of process 1300, in some implementations, MLME of sensing responder 1304 may send a modified poll response to MLME of sensing initiator 1302. At step 1314 of process 1300, in some implementations, MLME of sensing initiator 1302 may send MLME-SENSMSG.indication primitive to SME of sensing initiator 1302.

In an implementation, the multiway sensing trigger message may include an indication of bandwidth allocation for use by respective plurality of sensing responders 504-(1-M). In an implementation, respective bandwidth allocations for use by respective plurality of sensing responders 504-(1-M) may be determined according to sensing modes of respective ones of plurality of sensing responders 504-(1-M). In an example, respective bandwidth allocations may include at least two bandwidth allocations of different sizes. According to an implementation, the multiway sensing trigger message may re-use the ranging trigger frame (poll) configuration to allocate different uplink OFDMA RUs to different sensing responders 504-(1-M) for the modified poll response, enabling sensing initiator 502 to make sensing measurements simultaneously. In examples, this may allow sensing initiator 502 to allocate less sensing transmission RUs to a sensing responder 504 in a scanning mode of Wi-Fi sensing, the purpose of which is to detect whether or not there is motion in the sensing space. In an implementation, once motion is detected and if there is a need to make more precise measurements of the motion, then more sensing transmission RUs may be allocated to a sensing responder 504 in a detection mode of Wi-Fi sensing, as a sensing measurement made over a larger bandwidth (or more RUs) provides greater precision of the sensing measurement. In an example, the multiway sensing trigger message may include an indication of a first bandwidth allocation for use by first sensing responder 504-1 and an indication of a second bandwidth allocation for use by second sensing responder 504-2. The first bandwidth allocation may be allotted for detection mode sensing transmissions, and the second bandwidth allocation may be allotted for scanning mode sensing transmissions. In an example implementation, the first bandwidth allocation of first sensing responder 504-1 may be greater than the second bandwidth allocation of second sensing responder 504-2. The RU configuration process is described in detail later in the description.

According to an implementation, the multiway sensing trigger message may include requested sensing configuration parameters that sensing initiator 502 requests one or more of plurality of sensing responders 504-(1-M) to use for sensing transmissions. In an example, the requested sensing configuration parameters may include a plurality of specific sensing configuration parameter sets, each associated with a respective one of plurality of sensing responders 504-(1-M). In examples, the sensing configuration parameters may include requested transmission configuration parameters and requested steering matrix configuration parameters that sensing initiator 502 is requesting one or more of plurality of sensing responders 504-(1-M) to use for sensing transmissions. In an implementation, at least one of the plurality of sensing transmissions includes delivered sensing configuration parameters different than the requested sensing configuration parameters. Examples of sensing configuration parameters are described in detail later in the description.

According to an implementation, the multiway sensing trigger message and the modified polling response for Wi-Fi sensing may mimic the ranging polling phase. In an example, the multiway sensing trigger message is defined by a new Trigger Type subfield value of the reserved values (i.e., a new Trigger Type subfield value is defined). In examples, any Trigger Type subfield value not already used for a trigger frame variant may be used. In an example, the Trigger Type subfield value for a multiway sensing trigger message is Type 9, as illustrated in Table 4 provided below.

TABLE 4
New Trigger type subfield of Common Info field

| Trigger Type | |
|---|---|
| subfield value | Trigger frame variant |
| 0 | Basic |
| 1 | Beamforming Report Poll (BFRP) |
| 2 | MU-BAR |
| 3 | MU-RTS |
| 4 | Buffer Status Report Poll (BSRP) |
| 5 | GCR MU-BAR |
| 6 | Bandwidth Query Report Poll (BQRP) |
| 7 | NDP Feedback Report Poll (NRFP) |
| 8 | Ranging |
| 9 | Multiway Sensing Trigger Message |
| 10-15 | Reserved |

According to some implementations, the multiway sensing trigger message may include a request for a sensing transmission and an indication that no further action is required subsequent to the sensing transmission. In examples, a sensing responder 504 that receives a trigger frame with Trigger Type subfield value 9 (indicating that it is a multiway sensing trigger message) may terminate the triggered process after the sending of the modified poll response.

In examples, when the sensing responder 504 receives the trigger frame of this Trigger Type (the multiway sensing trigger message), the sensing responder 504 may be aware that sensing initiator 502 has requested that it sends modified poll response according to the requested sensing configuration parameters specified in the multiway sensing trigger message. In examples, sensing responder 504 may be aware that it has to abort the triggered process (i.e., not continue as it would with a normal “ranging” process) after sending the modified poll response. In examples, with the exception of the Trigger Type subfield, all other fields of the multiway sensing trigger message remain the same as the ranging trigger frame (poll).

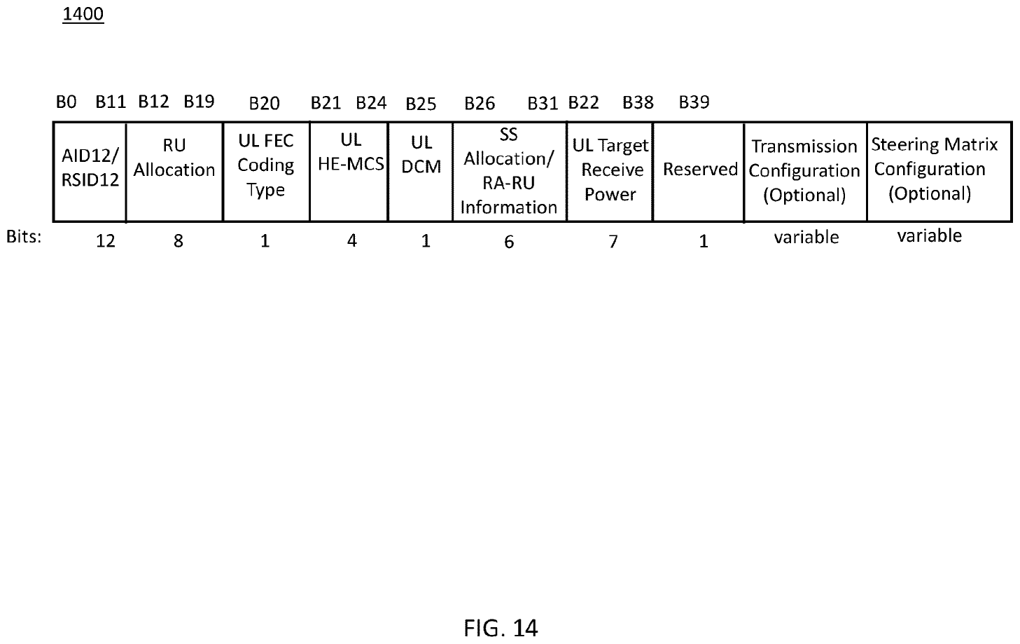

According to an implementation, in order to enable sensing initiator 502 to include sensing transmission configuration parameters for more than one sensing responder, two new subfields may be added to the User Info field. Format 1400 of the User Info field for the multiway sensing trigger message is depicted in FIG. 14, according to some embodiments. As shown in FIG. 14, following B39 which is a Reserved bit of the User Info field, in examples the User Info field of the multiway sensing trigger message includes an optional, variable length Transmission Configuration field. In examples, following B39 which is a Reserved bit of the User Info field, the multiway sensing trigger message includes an optional, variable length Steering Matrix Configuration field. The optional Transmission Configuration field and the optional Steering Matrix Configuration field may be included in any order after the fixed length fields in the User Info field of the multiway sensing trigger message. The optional Transmission Configuration field and the optional Steering Matrix Configuration field are described in more detail later in the description.

As described earlier, the TB sensing procedure includes four phases, namely, a polling phase, a UL NDP phase, a DL NDP phase, and a reporting phase. In examples, a flexible Wi-Fi sensing procedure under the control of sensing initiator 502 may be defined. For example, based on STA measurement requirements provided by a Wi-Fi sensing application, a mix of measurements may be implemented using portions of the ranging process. In examples as described above, a Wi-Fi sensing procedure comprises the polling phase (which includes the trigger frame (poll) and the modified poll response. In an example, sensing initiator 502 may perform a sensing measurement on modified polling response transmissions received from one or more sensing responders in the polling phase (without subsequently aborting the sensing procedure). In examples where the sensing procedure is not aborted, in addition to the polling phase, the Wi-Fi sensing procedure comprises the UL NDP/DL NDP phase, as shown and described with respect to FIG. 8. Sensing initiator 502 may then perform a sensing measurement on one or more sensing responders 504-(1-M) using the NDP transmission in the UL NDP/DL NDP phase.

As described above, modified polling response transmissions (during the polling phase) from sensing responders 504-(1-M) can be used by sensing initiator 502 to measure the transmission channel from multiple sensing responders, that is the modified polling response may be used as a sensing transmission from the multiple sensing responders 504-(1-M). In examples, using NDP transmissions for sensing measurements in the UL NDP/DL NDP phase enables sensing initiator 502 to perform both scanning mode sensing measurements and detection mode sensing measurements in a single measurement instance with a transmission opportunity. In examples, sensing responders participating in the UL NDP/DL NDP phase need to be included in the polling phase. As a result, sensing initiator 502 may assign a small amount of bandwidth to such sensing responders for the modified poll response, and the sensing initiator does not make a sensing measurement on the received modified poll response. In the example, the sensing initiator sends a further trigger frame to the sensing responders to trigger the sensing responder to transmit and UL NDP and the sensing measurement is made on the NDP in the UL NDP phase. Thus, sensing responders participating in the UL NDP/DL NDP phase can be assigned a small RU allocation in the polling phase to enable the sensing initiator 502 to receive modified polling responses from a large number of sensing responders, one or more of which will not participate in the UL NDP/DL NDP phase of the sensing procedure.

According to some implementations, the multiway sensing trigger message may be an enhanced ranging trigger frame (poll). The enhanced ranging trigger frame (poll) may be compatible for STAs that support ranging according to IEEE standard 802.11az but that do not support sensing. In examples, the enhanced ranging trigger frame (poll) may allow sensing initiator 502 to use a single trigger to elicit sensing transmissions in the form of modified poll responses from some STAs to be used for sensing measurements, and to trigger other STAs to follow the IEEE standard 802.11az ranging process. In an implementation, sensing algorithm 516, via the enhanced ranging trigger frame (poll), may be configured to request a sensing transmission response from a sensing responder (for example, from first sensing responder 504-1) of plurality of sensing responders 504-(1−M) and to request a non-sensing transmission response from an additional networking device (for example, from first ranging only responder 506-1) of plurality of ranging only responders 506-(1−N).

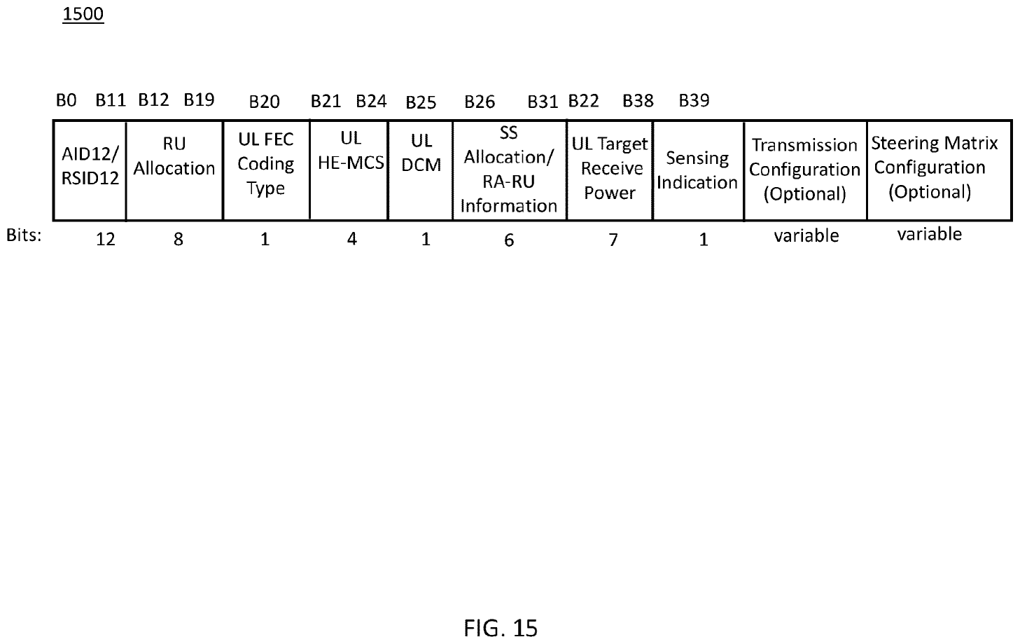

In examples, the enhanced ranging trigger frame (poll) may utilize the same format as the ranging trigger frame (poll), with the exception of the User Info field. In order to enhance the existing ranging trigger frame (poll) (Trigger Type 8) to enable sensing algorithm 516 to perform ranging with some STAs (for example, ranging only responders) and sensing with other STAs (for example, sensing responders), in an example, two additional fields may be added at the end of the User Info field as shown in FIG. 15. FIG. 15 depicts format 1500 of User Info field format for the enhanced ranging trigger frame (poll), according to some embodiments.

In examples, as shown in FIG. 15, the Reserved bit (B39) of the User Info field is modified to be used as a Sensing Indication bit. The Sensing Indication bit of the User Info field of the enhanced ranging trigger frame (poll) may be used by sensing initiator 502 to indicate to the STA identified by the AID/RSID if the ranging trigger frame (poll) is for a ranging procedure or for a sensing procedure. For example, STAs the support Wi-Fi sensing using ranging (i.e., sensing responders) addressed by the enhanced ranging trigger frame (poll) with a User Info field (based on their AID/RSID) check the Sensing Indication bit of the User Info field. In an example, if the sensing indication bit is set to zero (0), then this indicates to the identified sensing responder that sensing initiator 502 is requesting for the sensing responder to participate in a normal ranging procedure, and the optional subfields of the User Info field of the enhanced ranging trigger frame (poll) (Transmission Configuration and Steering Matrix Configuration) will not be present (the trigger frame will be a standard trigger frame of the Ranging Trigger type). In some examples, if the sensing indication bit is set to one (1), then this indicates to the identified sensing responder that sensing initiator 502 is requesting for the sensing responder to participate in a sensing procedure using the enhanced ranging trigger frame (poll). In this case, the sensing responder will check for the optional subfields (Transmission Configuration and Steering Matrix Configuration) in case they are present and have been sent to the sensing responder to request a specific transmission configuration. In examples, the sensing responder terminates the sensing procedure after the modified poll response is sent.

According to an implementation, if a sensing transmission is required from one or more sensing responders, then sensing initiator 502 may use the enhanced ranging trigger frame (poll) to combine the request for sensing transmissions from the sensing responders with a ranging trigger (poll) request (Trigger Type 8) to other STAs for which the sensing transmission was not requested (i.e., to make the most usage of the trigger frame). In an example, this procedure may be used to focus on evaluating a sensing responder for suitability in a sensing application. In order to determine if the sensing responder should be enabled to participate in a detection mode sensing application (e.g., fine resolution/full bandwidth measurements), a scanning mode sensing measurement may be performed. In examples, the scanning mode measurement may include a distance (obtained from the ranging aspect of the sensing procedure) between the sensing responder and sensing initiator 502, and a partial bandwidth scanning mode sensing measurement. In this manner, both distance and a sensing measurement may be captured for a sensing responder by executing the modified ranging procedure and with a multiway sensing trigger message and modified poll response.

According to an implementation, in response to receiving the multiway sensing trigger message or the enhanced ranging trigger frame (poll) with indication of AID/RSID of sensing responders (504-(1−M)), the identified sensing responders may transmit a modified poll response to sensing initiator 502 in the RU allocation provided by sensing initiator 502. In examples, the sensing responders may optionally configure the modified poll response transmission according to the requested sensing configuration parameters sent by sensing initiator 502 in the User Info field of the multiway sensing trigger message. In examples, the modified poll response may include additional optional fields. In an example, a sensing responder may include delivered sensing configuration parameters in the additional optional fields in the modified poll response transmissions, indicating to sensing initiator 502 the actual transmission configuration parameters that the sensing responder used to configure the modified poll response transmission. The delivered sensing configuration parameters may include delivered transmission configuration parameters and delivered steering matrix configuration parameters. In an implementation, the delivered sensing configuration parameters may be different than the requested sensing configuration parameters.

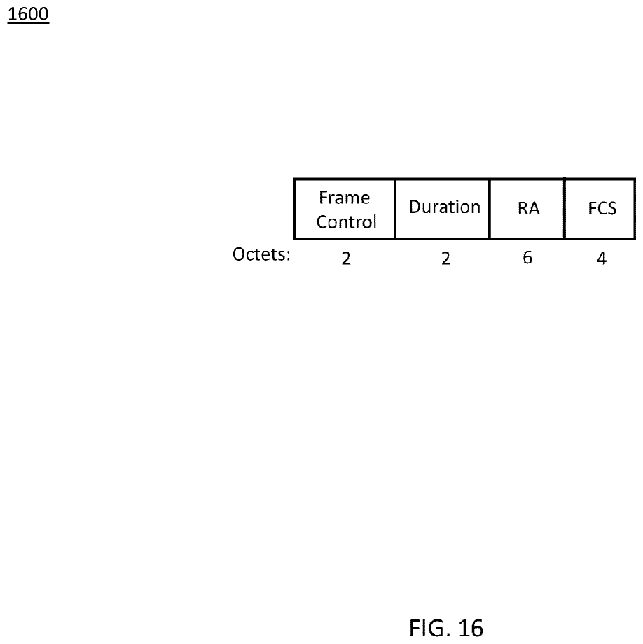

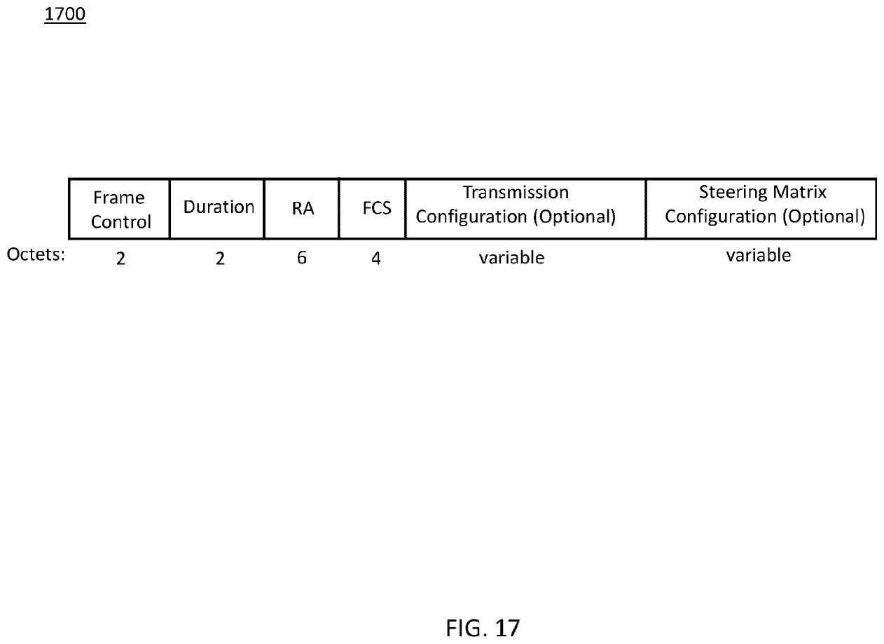

In an implementation, after transmitting the modified poll response, the sensing responders may exit or abort the sensing process (i.e., no more frames are transmitted or expected to be received by the STAs). Sensing initiator 502 may perform sensing measurements on one or more training fields in the modified poll responses. In examples, the modified poll response is a CTS-to-self, and format 1600 of the CTS frame is depicted in FIG. 16. FIG. 16 is a reproduction of FIG. 9-42 of Draft P802.11REVme_D1.1. In an example, if the “Duration” field of the modified poll response based on the CTS frame is set to zero (0), which may be an illegal or abnormal state for the Duration field according to Draft P802.11REVme_D1.1, sensing initiator 502 may know that delivered configuration parameters have been included by the sensing responder in optional variable fields appended to the CTS frame. FIG. 17 depicts format 1700 of a CTS frame modified for sensing based on ranging, according to some embodiments. As shown in FIG. 17, the two variable optional Transmission Configuration field and Steering Matrix Configuration field are appending to the CTS frame after the fixed bit fields. In examples, if the modified poll response in the form of a CTS-to-self is transmitted by the sensing responder as a sensing transmission in response to multiway sensing trigger message (Trigger Type 9) or enhanced ranging trigger frame (poll) (Trigger Type 8 with the Sensing Indication bit set as 1 (one)), then the Duration field of the CTS frame shown in FIG. 16 may be set as zero (0) and.

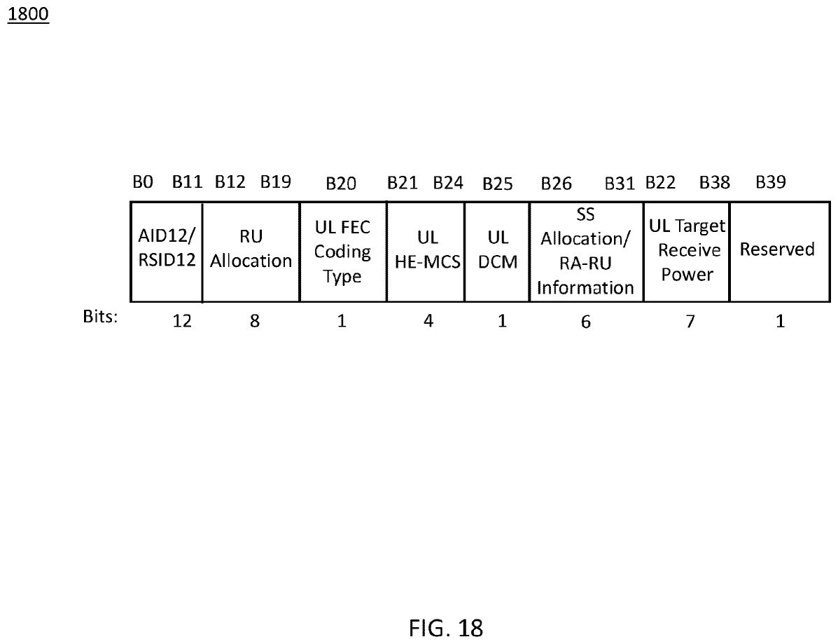

FIG. 18 illustrates format 1800 of the User Info field of the multiway sensing trigger message, according to some embodiments. FIG. 18 is a reproduction of FIG. 9-641c from Draft P802.11az_D4.1. In an implementation, the use of the UL BW subfield in the Common Info field of the ranging trigger frame (poll) (Trigger Type 8) and the multiway sensing trigger message (Trigger Type 9) is identical to the Basic Trigger frame (Trigger Type 0) (as described in Draft P802.11az_D4.1), which allows RU level allocations. The mapping of B7-B1 of the RU Allocation subfield is described in Table 5 provided below. Table 5 is a reproduction of Table 9-52 B7-B1 of the RU Allocation subfield from Draft P802.11REVme_D1.1.

TABLE 5
RU allocation for ranging poll response

| B7-B1 of | | | |
|---|---|---|---|
| the RU | | | |
| Allocation | | RU | |
| subfield | UL BW subfield | Size | RU Index |
| 0-8 | 20 MHz, 40 MHz, | 26 | RU1 to RU9, |
| | 80 MHz, 80 + 80 MHz, or | | respectively |
| | 160 MHz | | |
| 9-17 | 40 MHz, 80 MHz, | | RU10 to RU18, |
| | 80 + 80 MHz, or 160 MHz | | respectively |
| 18-36 | 80 MHz, 80 + 80 MHz, or | | RU19 to RU37, |
| | 160 MHz | | respectively |
| 37-40 | 20 MHz, 40 MHz, | 52 | RU1 to RU4, |
| | 80 MHz, 80 + 80 MHz, or | | respectively |
| | 160 MHz | | |
| 41-44 | 40 MHz, 80 MHz, | | RU5 to RU8, |
| | 80 + 80 MHz, or 160 MHz | | respectively |
| 45-52 | 80 MHz, 80 + 80 MHz, or | | RU9 to RU16, |
| | 160 MHz | | respectively |
| 53, 54 | 20 MHz, 40 MHz, | 106 | RU1 and RU2, |
| | 80 MHz, 80 + 80 MHz, or | | respectively |
| | 160 MHz | | |
| 55, 56 | 40 MHz, 80 MHz, | | RU3 and RU4, |
| | 80 + 80 MHz, or 160 MHz | | respectively |
| 57-60 | 80 MHz, 80 + 80 MHz, or | | RU5 to RU8, |
| | 160 MHz | | respectively |
| 61 | 20 MHz, 40 MHz, | 242 | RU1 |
| | 80 MHz, 80 + 80 MHz, or | | |
| | 160 MHz | | |
| 62 | 40 MHz, 80 MHz, | | RU2 |
| | 80 + 80 MHz, or 160 MHz | | |
| 63, 64 | 80 MHz, 80 + 80 MHz, or | | RU3 and RU4, |
| | 160 MHz | | respectively |
| 65 | 40 MHz, 80 MHz, | 484 | RU1 |
| | 80 + 80 MHz, or 160 MHz | | |
| 66 | 80 MHz, 80 + 80 MHz, or | | RU2 |
| | 160 MHz | | |
| 67 | 80 MHz, 80 + 80 MHz, or | 996 | RU1 |
| | 160 MHz | | |
| 68 | 80 + 80 MHz or 160 MHz | 2 × 996 | RU1 |

In an example, if UL BW subfield indicates 80+80 MHz or 160 MHz, the description indicates the RU index for the primary 80 MHz channel or secondary 80 MHz channel as indicated by B0 of the RU Allocation subfield.

If the UL BW subfield of the Common Info field of the trigger frame indicates 20 MHz, the mapping of the RU index to RUs is described in Table 6 provided below. Table 6 is a reproduction of Table 27-7 of Draft P802.11REVme_D1.1.

TABLE 6
RU allocation for 20 MHz channel bandwidth

| RU type | RU index and subcarrier range | | | | |
|---|---|---|---|---|---|
| 26-tone RU | RU 1 | RU 2 | RU 3 | RU 4 | RU 5 |
| | [−121: −96] | [−95: −70] | [−68: −43] | [−42: −17] | [−16: −4, 4: 16] |
| | RU 6 | RU 7 | RU 8 | RU 9 | |
| | [17: 42] | [43: 68] | [70: 95] | [96: 121] | |
| 52-tone RU | RU 1 | RU 2 | RU 3 | RU 4 | |
| | [−121: −70] | [−68: −17] | [17: 68] | [70: 121] | |

| | | |
|---|---|---|
| 106-tone RU | RU 1 | RU 2 |
| | [−122: −17] | [17: 122] |

| | |
|---|---|
| 242-tone RU | RU 1 |
| | [−122: −2, 2: 122] |

The subcarrier index of 0 corresponds to the DC tone. Negative subcarrier indices correspond to subcarriers with a frequency lower than the DC tone, and positive subcarrier indices correspond to subcarriers with a frequency higher than the DC tone. Further, RU 5 is the middle 26-tone RU.

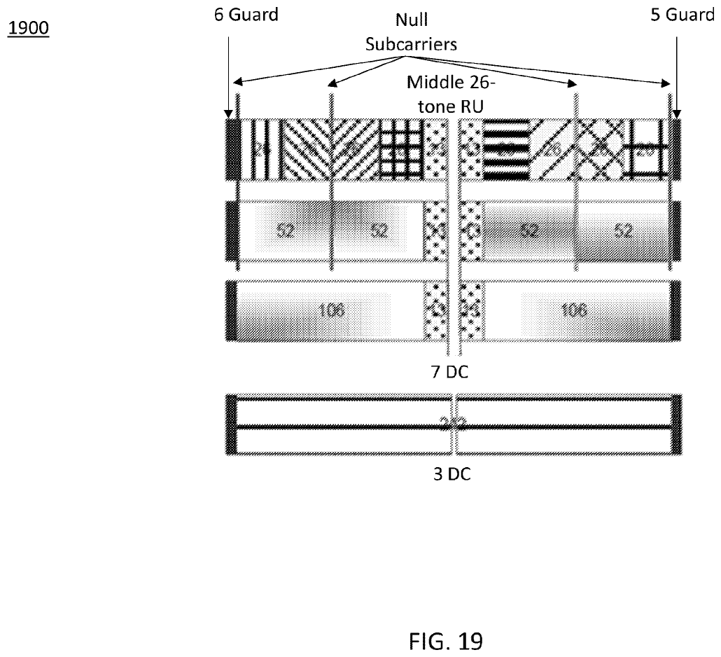

FIG. 19 depicts RU User Info field format 1900 for multiway sensing trigger message and enhanced ranging trigger frame (poll), according to some embodiments. FIG. 19 is a reproduction of FIG. 27-5—RU locations in a 20 MHz HE PP from of Draft P802.11REVme_D1.1.

For other larger channel bandwidths, the RU index and RU location figures are also defined similarly. If the UL BW subfield indicates 40 MHz, the mapping of the RU index to RU is defined in Table 6 in increasing order. For example, the increasing order of 26-tone RU is from RU1 to RU 18 as described in Table 7 provided below. Table 7 is a reproduction of Table 27-8 of Draft P802.11REVme_D1.1.

TABLE 7
RU allocation for 40 MHz channel bandwidth

| RU type | RU index and subcarrier range | | | | |
|---|---|---|---|---|---|
| 26-tone RU | RU 1 | RU 2 | RU 3 | RU 4 | RU 5 |
| | [−243: −218] | [−217: −192] | [−189: −164] | [−163: −138] | [−136: −111] |
| | RU 6 | RU 7 | RU 8 | RU 9 | |
| | [−109: −84] | [−83: −58] | [−55: −30] | [−29: −4] | |
| | RU 10 | RU 11 | RU 12 | RU 13 | RU 14 |
| | [4: 29] | [30: 55] | [58: 83] | [84: 109] | [111: 136] |
| | RU 15 | RU 16 | RU 17 | RU 18 | |
| | [138: 163] | [164: 189] | [192: 217] | [218: 243] | |
| 52-tone RU | RU 1 | RU 2 | RU 3 | RU 4 | |
| | [−243: −192] | [−189: −138] | [−109: −58] | [−55: −4] | |
| | RU 5 | RU 6 | RU 7 | RU 8 | |
| | [4: 55] | [58: 109] | [138: 189] | [192: 243] | |
| 106-tone | RU 1 | RU 2 | RU 3 | RU 4 | |
| RU | [−243: −138] | [−109: −4] | [4: 109] | [138: 243] | |

| | | |
|---|---|---|
| 242-tone | RU 1 | RU 2 |
| RU | [−244: −3] | [3: 244] |

| | |
|---|---|
| 484-tone | RU 1 |
| RU | [−244: −3, 3: 244] |

The subcarrier index of 0 corresponds to the DC tone. Negative subcarrier indices correspond to subcarriers with a frequency lower than the DC tone, and positive subcarrier indices correspond to subcarriers with a frequency higher than the DC tone.

If the UL BW subfield indicates 80 MHz, 160 MHz, or 80+80 MHz, the mapping of the RU index to RU is described in Table 8 (provided below) in increasing order. Table 8 is a reproduction of Table 27-9 of Draft P802.11REVme_D1.1.

TABLE 8
RU allocation for 80 MHz channel bandwidth

| RU type | RU index and subcarrier range | | | | |
|---|---|---|---|---|---|
| 26-tone RU | RU 1 | RU 2 | RU 3 | RU 4 | RU 5 |
| | [−499: −474] | [−473: −448] | [−445: −420] | [−419: −394] | [−392: −367] |
| | RU 6 | RU 7 | RU 8 | RU 9 | |
| | [−365: −340] | [−339: −314] | [−311: −286] | [−285: −260] | |
| | RU 10 | RU 11 | RU 12 | RU 13 | RU 14 |
| | [−257: −232] | [−231: −206] | [−203: −178] | [−177: −152] | [−150: −125] |
| | RU 15 | RU 16 | RU 17 | RU 18 | RU 19 |
| | [−123: −98] | [−97: −72] | [−69: −44] | [−43: −18] | [−16: −4, 4: 16] |
| | RU 20 | RU 21 | RU 22 | RU 23 | RU 24 |
| | [18: 43] | [44: 69] | [72: 97] | [98: 123] | [125: 150] |
| | RU 25 | RU 26 | RU 27 | RU 28 | |
| | [152: 177] | [178: 203] | [206: 231] | [232: 257] | |
| | RU 29 | RU 30 | RU 31 | RU 32 | RU 33 |
| | [260: 285] | [286: 311] | [314: 339] | [340: 365] | [367: 392] |
| | RU 34 | RU 35 | RU 36 | RU 37 | |
| | [394: 419] | [420: 445] | [448: 473] | [474: 499] | |
| 52-tone RU | RU 1 | RU 2 | RU 3 | RU 4 | |
| | [−499: −448] | [−445: −394] | [−365: −314] | [−311: −260] | |
| | RU 5 | RU 6 | RU 7 | RU 8 | |
| | [−257: −206] | [−203: −152] | [−123: −72] | [−69: −18] | |
| | RU 9 | RU 10 | RU 11 | RU 12 | |
| | [18: 69] | [72: 123] | [152: 203] | [206: 257] | |
| | RU 13 | RU 14 | RU 15 | RU 16 | |
| | [260: 311] | [314: 365] | [394: 445] | [448: 499] | |
| 106-tone | RU 1 | RU 2 | RU 3 | RU 4 | |
| RU | [−499: −394] | [−365: −260] | [−257: −152] | [−123: −18] | |
| | RU 5 | RU 6 | RU 7 | RU 8 | |
| | [18: 123] | [152: 257] | [260: 365] | [394: 499] | |
| 242-tone | RU 1 | RU 2 | RU 3 | RU 4 | |
| RU | [−500: −259] | [−258: −17] | [17: 258] | [259: 500] | |

| | | |
|---|---|---|
| 484-tone | RU 1 | RU 2 |
| RU | [−500: −17] | [17: 500] |

| . . . | . . . |
|---|---|
| 996-tone | RU 1 |
| RU | [−500: −3, 3: 500] |

The subcarrier index of 0 corresponds to the DC tone. Negative subcarrier indices correspond to subcarriers with a frequency lower than the DC tone, and positive subcarrier indices correspond to subcarriers with a frequency higher than the DC tone. Further, RU 19 is the center 26-tone RU. If the UL BW subfield indicates 160 MHz or 80+80 MHz, B7-B1 of the RU Allocation subfield is set to 68, and B0 is set to 1 to indicate a 2×996-tone RU. A non-AP STA ignores B0 for 2×996-tone RU indication. As described in FIG. 18, the solution of RU allocation works for sensing responders, associated STAs and unassociated STAS. In FIG. 18, the AID12/RSID12 subfield of the User Info field carries either the 12 LSBs of the AID for an associated ISTA or the 12 LSBs of the RSID for an unassociated ISTA.

According to an implementation, a requested transmission configuration may be sent from sensing initiator 502 to a sensing responder to request specific transmission parameters be used by the sensing responder. A delivered transmission configuration may be sent from the sensing responder to sensing initiator 502 to indicate the actual transmission parameters used by the sensing responder. The requested transmission configuration and the delivered transmission configuration values are described in Table 9 provided below.

TABLE 9
Transmission Configuration Elements

| | Message Type and | Transmission | |
|---|---|---|---|
| Position | Direction | Configuration | Steering Matrix Configuration |
| B40 | User Info subfield of | Optional | Optional |
| onwards | Common Info field of | If present, sensing | If present, this Element specifies |
| (variable) | multiway sensing | responder applies the | a steering matrix to use for |
| | trigger message | required transmission | sensing transmission by sensing |
| | sensing initiator to | configuration from | responder, or a series of steering |
| | sensing responder (or | this Element. | matrix configurations to use for |
| | sensing receiver to | | sensing transmissions of a |
| | sensing transmitter) | | measurement campaign. |
| | | | The steering matrix |
| | | | configuration(s) can be |
| | | | specified using indices into a |
| | | | pre-configured steering matrix |
| | | | configuration table, or specific |
| | | | beamforming weights for each |
| | | | transmit path or transmit |
| | | | antenna of the sensing responder |
| | | | may be specified. |
| Octet 15 | Modified Poll | Optional | Optional |
| onwards | Response | Option 1: | Option 1: Steering matrix |
| (variable) | sensing responder to | Transmission | configuration applied to this |
| | sensing initiator (or | parameters of this | transmission |
| | sensing transmitter to | transmission | Option 2: Index into a pre- |
| | sensing receiver) | (delivered | configured steering matrix |
| | | transmission | configuration table indicating |
| | | configuration) | the steering matrix |
| | | Option 2: A single | configuration applied to this |
| | | bit flag if the sensing | transmission |
| | | responder applies the | Option 3: This Element is |
| | | requested | absent if the sensing responder |
| | | transmission | applies the requested steering |
| | | configuration | matrix configuration |
| | | Option 3: This | |
| | | Element is absent if | |
| | | the sensing | |
| | | responder applies the | |
| | | requested | |
| | | transmission | |
| | | parameters | |

Table 9 describes the transmission configuration elements that may be part of a required transmission configuration or delivered transmission configuration. In an example, these extra data fields are encoded into an Element (Draft P802.11REVme_D1.1 § 9.4.2) for inclusion in the User Info subfield of Common Info field in the multiway sensing trigger message (requested transmission configuration) or in the modified poll response (delivered transmission configuration).

Transmission configuration elements and values are in Table 10 and steering configuration elements and values are in Table 11.

TABLE 10
Transmission Configuration Element Details

| Name | Type | Valid Range | Description |
|---|---|---|---|
| SensingSpatialConf- | Integer | 0 . . . 15 | Index into a table of |
| Index | | | steering matrix |
| | | | configurations, such as |
| | | | may be pre-configured for |
| | | | a sensing responder via a |
| | | | sensing configuration |
| | | | message and optionally |
| | | | acknowledged by a |
| | | | sensing configuration |
| | | | response message. |
| | | | 0 is always reserved to |
| | | | indicate no configuration |
| | | | requirement (e.g., the |
| | | | sensing responder may |
| | | | use a default spatial |
| | | | matrix configuration) and |
| | | | 15 is reserved to indicate |
| | | | for the sensing responder |
| | | | to apply the spatial matrix |
| | | | configuration specified by |
| | | | the SensingSpatialConf- |
| | | | Index |
| SensingSpatialConfSteeringMatrix | A set of spatial | As defined in | A series of steering |
| | steering vector | Table 11 | vectors values (i.e., |
| | values, for | (SensingSpatialConfSteeringMatrix | spatial matrix |
| | example a | details) | configurations) which are |
| | phase and gain | | applied to each of the |
| | value, or a real | | implemented antennas on |
| | (I) and | | the sensing responder |
| | imaginary (Q) | | prior to the sending of a |
| | value, each | | sensing transmission |
| | representing a | | |
| | spatial matrix | | |
| | configuration | | |

TABLE 11
SensingSpatialConfSteeringMatrix details

| Name | Type | Valid Range | Description |
|---|---|---|---|
| TransmissionAntenna- | Integer | 1 . . . 8 | Number of transmission antennas |
| Count | | | on the sensing responder used for |
| | | | sensing transmissions. |
| | | | Defines the number of |
| | | | SensingAntennaNSteeringVectorRe |
| | | | and |
| | | | SensingAntennaNSteeringVectorIm |
| | | | pairs that follow in the element. At |
| | | | least one antenna must be specified |
| SensingAntenna0- | Half-precision | | Real part of the steering vector for |
| SteeringVectorRe | float (16 bits) | | antenna 0 |
| SensingAntenna0- | Half-precision | | Imaginary part of the steering |
| SteeringVectorIm | float (16 bits) | | vector for antenna 0 |
| . | . | | . |
| . | . | | . |
| . | . | | . |
| SensingAntenna7- | Half-precision | | Real part of the steering vector for |
| SteeringVectorRe | float (16 bits) | | antenna 7 |
| SensingAntenna7- | Half-precision | | Imaginary part of the steering |
| SteeringVectorIm | float (16 bits) | | vector for antenna 7 |

FIG. 20 depicts flowchart 2000 for performing a sensing measurement on at least one of a plurality of sensing transmissions, according to some embodiments.

In a brief overview of an implementation of flowchart 2000, at step 2002, a multiway sensing trigger message may be transmitted by a networking device operating as sensing initiator 502 via its transmitting antenna 512. At step 2004, networking device operating as sensing initiator 502 via its receiving antenna 514 may receive a plurality of sensing transmissions from plurality of sensing responders 504-(1-M) transmitted responsive to the multiway sensing trigger message. At step 2006, networking device operating as sensing initiator 502 may perform a sensing on at least one of the plurality of sensing transmissions.

Step 2002 includes transmitting, via a transmitting antenna of a networking device, a multiway sensing trigger message. According to an implementation, networking device operating as sensing initiator 502 may be configured to transmit, via transmitting antenna 512, the multiway sensing trigger message to plurality of sensing responders 504-(1-M). In an example, the networking device may be an access point (AP) and plurality of sensing responders 504-(1-M) may be stations (STAs) associated with the AP. According to an implementation, the multiway sensing trigger message may be a sensing polling trigger frame. According to an implementation, the multiway sensing trigger message may be an enhanced ranging trigger frame (poll). In an implementation, the multiway sensing trigger message may be configured to request a sensing transmission response from one or more sensing responders (for example, from first sensing responder 504-1, second sensing responder 504-2, etc.) of plurality of sensing responders 504-(1−M) and to request a non-sensing transmission response from one or more additional networking devices (for example, from first ranging only responder 506-1, second ranging only responder 506-2, etc.) of plurality of ranging only responders 506-(1−N).

In an implementation, the multiway sensing trigger message may include respective indications of bandwidth allocation for use by respective plurality of sensing responders 504-(1−M). In examples, sensing responders 504-(1−M) may format a sensing transmission according to its respective bandwidth allocation in the multiway sensing trigger message. In an example, a first bandwidth allocation of first sensing responder 504-1 from plurality of sensing responders 504-(1−M) may be greater than a second bandwidth allocation of second sensing responder 504-2 from plurality of sensing responders 504-(1−M), wherein the first bandwidth allocation is allotted for detection mode sensing transmissions and the second bandwidth allocation is allotted for scanning mode sensing transmissions. According to an implementation, respective bandwidth allocations for use by respective plurality of sensing responders 504-(1−M) may be determined according to sensing modes of respective ones of plurality of sensing responders 504-(1−M). Further, the respective bandwidth allocations may include at least two bandwidth allocations of different sizes.

According to some embodiments, the multiway sensing trigger message may include respective requested sensing configuration parameters for one or more sensing responders. In examples, the sensing configuration parameters may include a plurality of specific sensing configuration parameter sets, each associated with a respective one of the one or more sensing responders 504-(1−P), (P≤M). In some implementations, the multiway sensing trigger message may include a request for a sensing transmission and an indication that no further action is required subsequent to the sensing transmission.

In examples, the multiway sensing trigger message may be an enhanced ranging trigger frame (poll) which requests one or more sensing responders 504-(1−P), (P≤M), to transmit sensing transmissions in the form of a modified poll response, and in the same multiway sensing trigger message requests one or more ranging only responders 506-(1−Q), (Q≤N), to transmit a ranging poll response.

Step 2004 includes receiving simultaneously, via a receiving antenna of the networking device, a plurality of sensing transmissions from a plurality of sensing responders responsive to the multiway sensing trigger message. According to an implementation, the networking device operating as sensing initiator 502 may be configured to receive simultaneously, via receiving antenna 514, a plurality of sensing transmissions from plurality of sensing responders 504-(1−M) responsive to the multiway sensing trigger message. The term “simultaneously” may imply the networking device operating as sensing initiator 502 may receive the plurality of sensing transmissions during a same transmission opportunity period. In examples, the term “simultaneously” may imply the networking device operating as sensing initiator 502 may receive the plurality of sensing transmissions during a sensing measurement instance. In examples, the “simultaneously” may imply the networking device operating as sensing initiator 502 may receive the plurality of sensing transmissions responsive to a single multiway sensing trigger message. In examples, “simultaneously” may imply the networking device operating as sensing initiator 502 may receive the plurality of sensing transmissions during a sensing measurement session, i.e., in the context of a sensing measurement session that has been established and has not been terminated. In some implementations, the networking device operating as sensing initiator 502 may receive the plurality of sensing transmissions within a time interval of defined length. In examples, “simultaneously” may imply the networking device operating as sensing initiator 502 may receive the plurality of sensing transmissions within a maximum period of time, for example within 1 ms, within 5 ms, within 10 ms, within 50 ms, or within 100 ms for example.

In some implementations, the networking device operating as sensing initiator 502 may identify each of the plurality of sensing transmissions in a different bandwidth allocation. For example, the networking device operating as sensing initiator 502 may associated a sensing transmission received in a set of RUs with a sensing responder for which the sensing initiator assigned the set of RUs in the User Info field of the multiway sensing trigger message.

In examples, at least one of the plurality of sensing transmissions from one or more sensing responders 504-(1−P) may apply requested transmission configuration parameters sent by the networking device operating as sensing initiator 502 in the User Info field of the multiway sensing trigger message. In such examples, sensing responder 504-(1−P) may optionally include delivered transmission configuration parameters in a variable optional field of the modified poll response frame based on the CTS frame structure, where the delivered transmission configuration parameters are the same as the requested transmission configuration parameters. According to an implementation, at least one of the plurality of sensing transmissions from one or more sensing responders 504-(1−P) may receive requested transmission configuration parameters sent by the networking device operating as sensing initiator 502 in the User Info field of the multiway sensing trigger message and may choose to apply some portion of the requested transmission configuration parameters, or may choose to not apply any portion of the requested transmission configuration parameters. In such examples, sensing responders 504-(1−P) may optionally include delivered sensing configuration parameters different than the requested sensing configuration parameters, in a variable optional field of the modified poll response frame based on the CTS frame structure, where the delivered transmission configuration parameters reflect the transmission parameters applied by each sensing responder 504 to its sensing transmission.

Step 2006 includes performing a sensing measurement on at least one of the plurality of sensing transmissions. According to an implementation, the networking device operating as sensing initiator 502 may be configured to perform the sensing measurement on at least one of the plurality of sensing transmissions. In examples, networking device operating as sensing initiator 502 may perform sensing measurements according to the RU allocation for a respective sensing responder, where the RU allocation was included in the multiway sensing trigger message. In examples, networking device operating as sensing initiator 502 may perform sensing measurements on one or more modified poll response transmissions from one or more sensing responders and may not perform sensing measurements on ranging poll response transmissions from one or more ranging only responders. In examples, networking device operating as sensing initiator 502 may perform sensing measurements on one or more modified poll response transmissions from a first number of sensing responders and may subsequently perform sensing measurements on one or more UL NDP transmissions from a second number of sensing responders. In examples, the first number of sensing responders may be greater than the second number of sensing responders. In examples, the average RU allocation to the first number of sensing responders may be less than the average RU allocation to the second number of sensing responders.

### Additional Embodiments Include

Embodiment 1 is a method for Wi-Fi sensing carried out by a networking device configured to operate as a sensing initiator and including at least one processor configured to execute instructions, the method comprising: transmitting, via a transmitting antenna of the networking device, a multiway sensing trigger message; receiving simultaneously, via a receiving antenna of the networking device, a plurality of sensing transmissions from a plurality of sensing responders responsive to the multiway sensing trigger message; performing, by the at least one processor, a sensing measurement on at least one of the plurality of sensing transmissions.

Embodiment 2 is the method of embodiment 1, wherein the multiway sensing trigger message includes an indication of bandwidth allocation for use by the respective plurality of sensing responders.

Embodiment 3 is the method of embodiment 2, wherein a first bandwidth allocation of a first sensing responder from the plurality of sensing responders is greater than a second bandwidth allocation of a second sensing responder from the plurality of sensing responders.

Embodiment 4 is the method of embodiment 3, wherein the first bandwidth allocation is allotted for detection mode sensing transmissions and the second bandwidth allocation is allotted for scanning mode sensing transmissions.

Embodiment 5 is the method of any of embodiments 2-4, wherein respective bandwidth allocations for use by the respective plurality of sensing responders are determined according to sensing modes of respective ones of the plurality of sensing responders.

Embodiment 6 is the method of embodiment 5, wherein the respective bandwidth allocations include at least two bandwidth allocations of different sizes.

Embodiment 7 is the method of any of embodiments 1-6, wherein the multiway sensing trigger message includes requested sensing configuration parameters.

Embodiment 8 is the method of embodiment 7, wherein the sensing configuration parameters include a plurality of specific sensing configuration parameter sets, each associated with a respective one of the plurality of sensing responders.

Embodiment 9 is the method of any of embodiments 7-8, wherein at least one of the plurality of sensing transmissions includes delivered sensing configuration parameters different than the requested sensing configuration parameters.

Embodiment 10 is the method of any of embodiments 1-9, wherein the multiway sensing trigger message includes a request for a sensing transmission and an indication that no further action is required subsequent to the sensing transmission.

Embodiment 11 is the method of any of embodiments 1-10, wherein the multiway sensing trigger message is a Sensing Polling Trigger Frame.

Embodiment 12 is the method of any of embodiments 1-11, wherein the multiway sensing trigger message is configured to request a sensing transmission response from a sensing responder of the plurality of sensing responders and to request a non-sensing transmission response from an additional networking device.

Embodiment 13 is the method of any of embodiments 1-12, wherein receiving simultaneously the plurality of sensing transmissions includes receiving the plurality of sensing transmissions during a same transmission opportunity period.

Embodiment 14 is the method of any of embodiments 1-13, wherein receiving simultaneously the plurality of sensing transmissions includes receiving the plurality of sensing transmissions within a time interval of defined length.

Embodiment 15 is the method of any of embodiments 1-14, wherein receiving simultaneously the plurality of sensing transmissions includes identifying each of the plurality of sensing transmissions in a different bandwidth allocation.

Embodiment 16 is the method of any of embodiments 1-15, wherein the networking device is an access point and the respective plurality of sensing responders are stations associated with the access point.

Embodiment 17 is a system for Wi-Fi sensing comprising: a networking device configured to operate as a sensing initiator and including at least one processor configured to execute instructions for: transmitting, via a transmitting antenna of the networking device, a multiway sensing trigger message; receiving simultaneously, via a receiving antenna of the networking device, a plurality of sensing transmissions from a plurality of sensing responders responsive to the multiway sensing trigger message; performing, by the at least one processor, a sensing measurement on at least one of the plurality of sensing transmissions.

Embodiment 18 is the system of embodiment 17, wherein the multiway sensing trigger message includes an indication of bandwidth allocation for use by the respective plurality of sensing responders.

Embodiment 19 is the system of embodiment 18, wherein a first bandwidth allocation of a first sensing responder from the plurality of sensing responders is greater than a second bandwidth allocation of a second sensing responder from the plurality of sensing responders.

Embodiment 20 is the system of embodiment 19, wherein the first bandwidth allocation is allotted for detection mode sensing transmissions and the second bandwidth allocation is allotted for scanning mode sensing transmissions.

Embodiment 21 is the system of any of embodiments 18-20, wherein respective bandwidth allocations for use by the respective plurality of sensing responders are determined according to sensing modes of respective ones of the plurality of sensing responders.

Embodiment 22 is the system of embodiment 21, wherein the respective bandwidth allocations include at least two bandwidth allocations of different sizes.

Embodiment 23 is the system of any of embodiments 17-22, wherein the multiway sensing trigger message includes requested sensing configuration parameters.

Embodiment 24 is the system of any of embodiments 17-23, wherein the sensing configuration parameters include a plurality of specific sensing configuration parameter sets, each associated with a respective one of the plurality of sensing responders.

Embodiment 25 is the system of any of embodiments 17-24, wherein at least one of the plurality of sensing transmissions includes delivered sensing configuration parameters different than the requested sensing configuration parameters.

Embodiment 26 is the system of any of embodiments 17-25, wherein the multiway sensing trigger message includes a request for a sensing transmission and an indication that no further action is required subsequent to the sensing transmission.

Embodiment 27 is the system of any of embodiments 17-26, wherein the multiway sensing trigger message is a Sensing Polling Trigger Frame.

Embodiment 28 is the system of any of embodiments 17-27, wherein the multiway sensing trigger message is configured to request a sensing transmission response from a sensing responder of the plurality of sensing responders and to request a non-sensing transmission response from an additional networking device.

Embodiment 29 is the system of any of embodiments 17-28, wherein receiving simultaneously the plurality of sensing transmissions includes receiving the plurality of sensing transmissions during a same transmission opportunity period.

Embodiment 30 is the system of any of embodiments 17-29, wherein receiving simultaneously the plurality of sensing transmissions includes receiving the plurality of sensing transmissions within a time interval of defined length.

Embodiment 31 is the system of any of embodiments 17-30, wherein receiving simultaneously the plurality of sensing transmissions includes identifying each of the plurality of sensing transmissions in a different bandwidth allocation.

Embodiment 32 is the system of any of embodiments 17-31, wherein the networking device is an access point and the respective plurality of sensing responders are stations associated with the access point.

While various embodiments of the methods and systems have been described, these embodiments are illustrative and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the illustrative embodiments and should be defined in accordance with the accompanying claims and their equivalents.

1. A method for Wi-Fi sensing carried out by a networking device configured to operate as a sensing initiator and including at least one processor configured to execute instructions, the method comprising:
transmitting, via a transmitting antenna of the networking device, a multiway sensing trigger message;
receiving simultaneously, via a receiving antenna of the networking device, a plurality of sensing transmissions from a plurality of sensing responders responsive to the multiway sensing trigger message;
performing, by the at least one processor, a sensing measurement on at least one of the plurality of sensing transmissions.

2. The method of claim 1, wherein the multiway sensing trigger message includes an indication of bandwidth allocation for use by the respective plurality of sensing responders.

3. The method of claim 2, wherein a first bandwidth allocation of a first sensing responder from the plurality of sensing responders is greater than a second bandwidth allocation of a second sensing responder from the plurality of sensing responders.

4. The method of claim 3, wherein the first bandwidth allocation is allotted for detection mode sensing transmissions and the second bandwidth allocation is allotted for scanning mode sensing transmissions.

5. The method of claim 2, wherein respective bandwidth allocations for use by the respective plurality of sensing responders are determined according to sensing modes of respective ones of the plurality of sensing responders.

6. The method of claim 5, wherein the respective bandwidth allocations include at least two bandwidth allocations of different sizes.

7. The method of claim 1, wherein the multiway sensing trigger message includes requested sensing configuration parameters.

8. The method of claim 7, wherein the sensing configuration parameters include a plurality of specific sensing configuration parameter sets, each associated with a respective one of the plurality of sensing responders.

9-10. (canceled)

11. The method of claim 1, wherein the multiway sensing trigger message is a Sensing Polling Trigger Frame.

12-13. (canceled)

14. The method of claim 1, wherein receiving simultaneously the plurality of sensing transmissions includes receiving the plurality of sensing transmissions within a time interval of defined length.

15-16. (canceled)

17. A system for Wi-Fi sensing comprising:
a networking device configured to operate as a sensing initiator and including at least one processor configured to execute instructions for:
transmitting, via a transmitting antenna of the networking device, a multiway sensing trigger message;
receiving simultaneously, via a receiving antenna of the networking device, a plurality of sensing transmissions from a plurality of sensing responders responsive to the multiway sensing trigger message;
performing, by the at least one processor, a sensing measurement on at least one of the plurality of sensing transmissions.

18. The system of claim 17, wherein the multiway sensing trigger message includes an indication of bandwidth allocation for use by the respective plurality of sensing responders.

19. The system of claim 18, wherein a first bandwidth allocation of a first sensing responder from the plurality of sensing responders is greater than a second bandwidth allocation of a second sensing responder from the plurality of sensing responders.

20. The system of claim 19, wherein the first bandwidth allocation is allotted for detection mode sensing transmissions and the second bandwidth allocation is allotted for scanning mode sensing transmissions.

21. The system of claim 18, wherein respective bandwidth allocations for use by the respective plurality of sensing responders are determined according to sensing modes of respective ones of the plurality of sensing responders.

22. The system of claim 21, wherein the respective bandwidth allocations include at least two bandwidth allocations of different sizes.

23. The system of claim 17, wherein the multiway sensing trigger message includes requested sensing configuration parameters.

24. The system of claim 23, wherein the sensing configuration parameters include a plurality of specific sensing configuration parameter sets, each associated with a respective one of the plurality of sensing responders.

25-26. (canceled)

27. The system of claim 17, wherein the multiway sensing trigger message is a Sensing Polling Trigger Frame.

28-29. (canceled)

30. The system of claim 17, wherein receiving simultaneously the plurality of sensing transmissions includes receiving the plurality of sensing transmissions within a time interval of defined length.

31-32. (canceled)
